(19) United States
(12) Patent Application Publication
(10) Pub. No.: US 2026/0192734 A1
(43) Pub. Date: Jul. 9, 2026

(54) UNIVERSAL SLIDE OUT PAN FOR RECREATIONAL MOTOR VEHICLE

(71) Applicant: Forest River, Inc., Elkhart, IN (US)

(72) Inventors: Ira Mullett, Shipshewana, IN (US); Henry McCormick, Goshen, IN (US)

(21) Appl. No.: 19/441,177

(22) Filed: Jan. 6, 2026

Related U.S. Application Data
(60) Provisional application No. 63/742,899, filed on Jan. 8, 2025.

(51) Int. Cl. B60P 3/36; B62D 25/24

(52) U.S. Cl. CPC B60P 3/36; B62D 25/24

(57) ABSTRACT

A recreational travel trailer includes a chassis and a body supported by the chassis. The body includes a side wall that forms an opening. The recreational travel trailer includes a slide assembly movably coupled relative to the side wall and a pan assembly coupled to an edge of the side wall, the edge of the side wall at least partially defining the opening. The pan assembly includes a pan and a support member, wherein the support member is removably coupled to the pan and configured to at least partially support the slide out assembly.

### CROSS REFERENCE TO RELATED APPLICATIONS

This application claims the benefit of U.S. Provisional Application No. 63/742,899 filed on January 8, 2025, the contents of which are hereby incorporated herein in their entirety.

### FIELD OF THE DISCLOSURE

The present disclosure relates to a travel trailer, and more particularly to a universal slide out pan for a travel trailer.

### BACKGROUND

Recreational fifth wheel travel trailers provide individuals with spacious, comfortable and transportable lodging. In particular, a typical fifth wheel travel trailer comprises a housing member having a multi-level interior living space formed therein, a multi-level chassis adapted to support the housing member, and a carriage member having a plurality of wheels interposed between the chassis and a supporting surface so as to enable the trailer to travel on the supporting surface. Furthermore, the typical fifth wheel trailer is adapted to detachably mount to a towing vehicle so that a front end of the trailer extends beyond the load bearing rear wheels of the towing vehicle so as to enable the towing vehicle to essentially act as a fifth wheel.

Since fifth wheel trailers are currently available with lengths as great as forty-five feet (and possibly longer) and pop-out sections that provide the housing member with increased width, their interior living spaces are able to resemble that of a nicely appointed home. For example, a fifth wheel travel trailer can include a large kitchen, a large bathroom, a large bedroom, and a large living area. Moreover, these trailers typically include multiple water storage tanks for supplying hot and cold water as well as for storing waste water, wiring for distributing electrical power and a central heating/ventilation/air conditioning (HVAC) system for providing desirable environmental conditions within the interior living space.

### SUMMARY

One embodiment of this disclosure is a recreational travel trailer. The recreational travel trailer includes a chassis, a body supported by the chassis, the body including a side wall that forms an opening, a slide out assembly movably coupled relative to the side wall, and a pan assembly coupled to an edge of the side wall, the edge of the side wall at least partially defining the opening. The pan assembly includes a pan and a support member. The support member is removably coupled to the pan and configured to at least partially support the slide out assembly.

One example of this embodiment, the pan includes a top surface of the pan formed by an inner most edge and an outer most edge, wherein the top surface slopes downwardly from the inner most edge to the outer most edge. In one example of this embodiment, the support member is made of high impact polypropylene. In another example of this embodiment, the pan assembly further includes a drip cup assembly coupled to at least one end of the pan. The drip cup assembly includes a drip cup configured drain a fluid away positioned thereon away from the opening, and a drip cup wipe coupled to the drip cup. In a further example of this embodiment, the drip cup includes a first portion and a second portion, the first portion and the second portion at least partially defining a gap configured to receive part of the pan. In yet another example of this embodiment, the drip cup includes an upper surface formed by a drip cup inner edge and a drip cup outer edge, wherein the upper surface slopes downwardly from the drip cup inner edge and the drip cup outer edge.

Another embodiment of this disclosure is a pan assembly for a recreational travel trailer including a slide out assembly. The pan assembly includes a pan, a support member removably coupled to the pan, a first wipe coupled to the pan, and at least one drip cup coupled to an end of the pan assembly. The support member is configured to at least partially support the slide out assembly and the at least one drip cup is configured to drain a fluid positioned thereon away from the travel trailer.

In one example of this embodiment, the pan includes a top surface formed between an inner most edge and outer most edge, the top surface sloping downwardly from the inner most edge to the outer most edge. In another example of this embodiment, the first wipe is coupled to an outer most edge of the pan, the first wipe configured to prevent debris from entering the travel trailer between the pan and the slide out assembly when the pan assembly is coupled to the travel trailer. In yet another example, the end of the pan is at least partially positioned above the at least one drip cup to facilitate a removal of fluid from the pan into the at least one drip cup. In one example of this embodiment, the support member is a wear bar. In another example of this embodiment, the support member is a roller.

In one example of this embodiment, the support member is one of a wear bar or a roller, and the pan assembly further comprises a second support member, the second support member being one of a wear bear or a roller. In a further example of this embodiment, the support member is coupled to the pan at a first attachment section, the second support member is coupled to the pan at a second attachment section, the first attachment section positioned between the first wipe and the second attachment section. In another example of this embodiment, the at least one drip cup includes a first portion and a second portion defining a gap, wherein the pan assembly is at least partially positioned within the gap of the at least one drip cup.

Yet another embodiment of this disclosure is a method of assembly a pan assembly to a travel trailer having a slide out assembly. The method includes coupling a pan to a lower edge of a wall of the travel trailer, the lower edge at least partially defining an opening in the wall and removably coupling a support member to the pan. The support member is configured to at least partially support the slide out assembly.

One example of this embodiment includes removably coupling a second support member to the pan, wherein the second support member is configured to a least partially support the slide out assembly. Another example of this embodiment includes removably coupling the support member on a first attachment section of the pan wherein the support member is touching a first protrusion extending from the pan.

One example of this embodiment includes coupling a first drip cup on the lower edge adjacent a first end of the pan, wherein the drip cup is configured to drain a fluid positioned thereon away from the opening. A further example of this embodiment includes positioning the pan at least partially above the first drip cup to facilitate a removal of fluid from the pan into the at least one drip cup.

Further embodiments, forms, features, and aspects of the present application shall become apparent from the description and figures provided herewith.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a side view of a fifth wheel travel trailer;

FIG. 2 is a partial perspective view of a slide out assembly of a travel trailer;

FIG. 3A is a cross sectional view of the travel trailer of FIG. 2 with the slide out assembly positioned in an open or at least partially open position;

FIG. 3B is a cross sectional view of the travel trailer of FIG. 2 with the slide out assembly positioned in a closed position;

FIG. 4A is a partial perspective view of the travel trailer of FIG. 2 with a universal slide out pan.

FIG. 4B is a partial perspective view of the universal slide out pan of FIG. 4A;

FIG. 4C is a partial perspective view of the universal slide out pan of FIG. 4A;

FIG. 4D is a perspective view of a pan of the universal slide out pan of FIG. 4A;

FIG. 5 is a cross-sectional side view of a support member of a universal slide out pan;

FIG. 6 is a perspective view of a support member;

FIG. 7 is a perspective view of a pan;

FIG. 8 is a cross sectional view of the pan of FIG. 7

FIG. 9A is a cross sectional view of a pan assembly;

FIG. 9B is a cross sectional view of a pan assembly;

FIG. 10 is a perspective view of a pan;

FIG. 11 is a cross sectional view of the pan of FIG. 10;

FIG. 12A is a cross sectional view of a pan assembly;

FIG. 12B is a cross sectional view of a pan assembly;

FIG. 12C is a cross sectional view of a pan assembly;

FIG. 12D is a cross sectional view of a pan assembly;

FIG. 12E is a cross sectional view of a pan assembly;

FIG. 12F is a cross sectional view of a pan assembly;

FIG. 12G is a cross sectional view of a pan assembly;

FIG. 12H is a cross sectional view of a pan assembly;

FIG. 13 is a perspective view of a drip cup assembly;

FIG. 14A is a perspective view of a first drip cup and a second drip cup;

FIG. 14B is a top view of the first drip cup and second drip cup of FIG. 14A;

FIG. 14C is a perspective view of the first drip cup and second drip cup of FIG. 14A located on a travel trailer;

FIG. 15 is a cross sectional view of a pan;

FIG. 16A is a cross sectional view of a pan assembly; and

FIG. 16B is a cross sectional view of a pan assembly.

Corresponding reference numerals are used to indicate corresponding parts throughout the several views.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Items listed in the form of “A, B, and/or C” can also mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in certain specific arrangements and/or orderings. However, it should be appreciated that such specific arrangements and/or orderings may not necessarily be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may be omitted or may be combined with other features.

The term “fastener” used herein, may be in the form of, but is not limited to, a screw, a nail, a bolt, a rivet, and/or a clamp. Any other fastener known in the art may also be used.

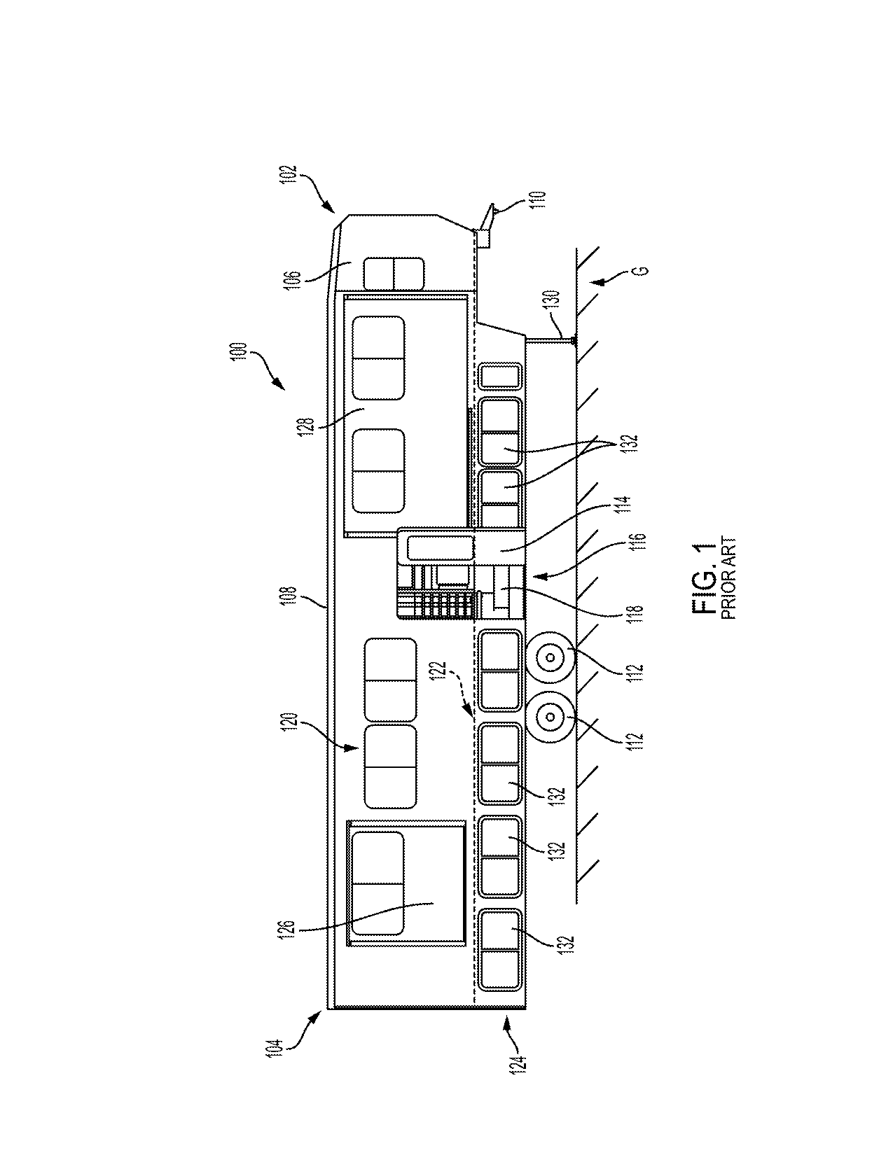

Referring to FIG. 1, an embodiment of a fifth wheel travel trailer 100 is illustrated. This trailer 100 may include a front end 102 and a rear end 104. For instance, an interior floor 122 of the trailer 100 may lie along a substantially horizontal plane between the front 102 and rear 104 thereof. The single-level trailer 100 may be formed as a body 106 supported by a frame assembly or chassis (not shown). The frame assembly or chassis may be a drop frame assembly or a straight frame assembly. The body 106 and frame assembly may be further supported by one or more wheels 112.

The body 106 may include an overhead roof 108 as shown in FIG. 1. Further, a hitch 110 may be located at the front end 102 of the trailer for coupling to a towing vehicle (not shown). When the trailer 100 is disconnected from the towing vehicle, a support member 130 or landing gear may be provided to support the front end 102 thereof.

The body 106 may include skirting (not shown). In other embodiments, the trailer may not include any skirting.

A door 114 may be coupled to the body 106 to allow access between the interior of the trailer 100 and outside thereof. The door 114, when opened, allows access to an entryway 116 which may be accessed by a set of steps 118 between the ground, G, and a living area 120 of the trailer 100. In one embodiment, the entryway 116 may have a width greater than the typical 30” found on some multi-level fifth wheel trailers. For instance, the passageway 116 may have a width between 30-40 inches. In a further example, the width may be between 32-38 inches. In yet a further example, the width may be approximately 36 inches. The present disclosure is not intended to be limited to any type of width of the entryway 116.

The trailer 100 may include a first slide out 126 and a second slide out 128. The slide outs, when configured in their deployed positions, allow the single-level living area 120 to increase in living space as the side wall of the body 106 moves outwardly a predetermined distance. While the trailer 100 of FIG. 1 includes a pair of slide outs, this is not intended to be limiting. The trailer 100 may include any number of slide outs for purposes of the present disclosure.

The travel trailer may include a height defined between the floor 122 and ceiling. In some embodiments, the height may be approximately the same throughout, whereas in other embodiments, the height may vary between the front 102 and rear 104. In FIG. 1, a first height, H₁, at the rear 104 of the trailer 100 may be approximately, if not exactly, the same as a second height, H₂, at the front 102 thereof. For example, the heights may be up to 84 inches. Conventional multi-level fifth wheel travel trailers having varying heights throughout the interior living spaces depending upon the location therein. For instance, a conventional multi-level fifth wheel may have heights that vary between 75 inches and 105 inches, where the less headroom is normally found in those living spaces that are elevated at the front and/or rear of the trailer.

The floor level 122 may separate the living space 120 of the trailer 100 from a storage compartment or basement 124. The storage compartment 124 may be accessed by any one of a plurality of storage doors 132. The storage compartment 124 of the travel trailer 100 of FIG. 1 may be individual compartments or a full pass-through storage space that runs continuously (e.g., uninterrupted) from the rear end 104 of the trailer 100 to a location towards the front end 102 thereof. In FIG. 1, for example, the storage compartment 124 may be a continuous space defined between point A at the rear 104 and point B towards the front 102. The storage compartment 124 may be formed of a single piece of composite material which can reduce the overall cost of the trailer 100. In other embodiments, the storage compartment 124 may be formed of other material besides composite.

In many conventional travel trailers and other recreational vehicles that include one or more slide outs, there are often problems with the wear bars of the slide out pan after they become damaged or need replaced. In many conventional slide out assemblies, the slide out extends and retracts where the slide out rubs against the wear bar. Wear bars can often get worn, torn, or damaged due to this rubbing and additionally from the weather such as from the water, snow and ice. As wear bars get worn or damaged, there can be issues with supporting and moving the slide out. Additionally, as wear bars get worn or damaged, there can be issues with leakage. Once a leak forms, fluid, for example, water, can easily get into the travel trailer and create mold issues or other structural damage. Traditionally, if a different wear bar is wanted, the whole slide out pan typically needs replaced and an entire new slide out pan installed to accommodate the needs of the wear bar. Thus, there is a need for an improved means for a new universal slide out pan.

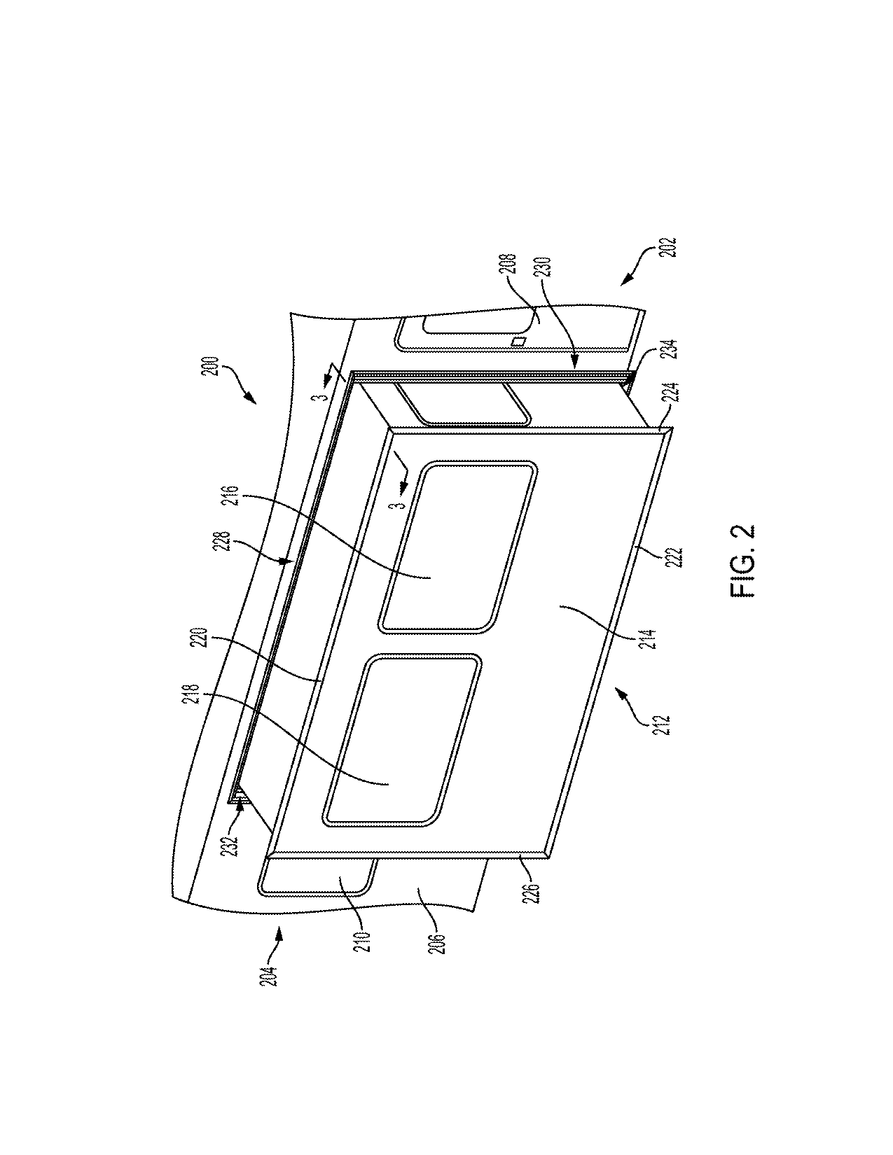

Referring to FIG. 2 of the present disclosure, one embodiment of a travel trailer or other recreational vehicle (e.g., fifth wheel trailer, etc.) is disclosed. In one embodiment, the travel trailer may be a powered vehicle having a power system (e.g., engine, transmission, etc.) for propelling it in a travel direction. In another embodiment, the travel trailer may be towed or pulled by a powered vehicle (e.g., a truck) in a travel direction. Other embodiments are contemplated and fit within the scope of the present disclosure.

The travel trailer 200 of FIG. 2 is partially shown but may include features similar to those disclosed in FIG. 1. The trailer 200 may include a front end 202, a rear end 204, and an outer wall or side wall 206. Similar to the embodiment of FIG. 1, the travel trailer 200 may include an entry opening in the side wall 206 whereby a door 208 provides access to an interior of the travel trailer 200. Moreover, in at least some embodiments, the travel trailer 200 may include one or more windows. In FIG. 2, for example, the trailer 200 may include a first window 210.

In some embodiments, the travel trailer 200 may include one or more slide out assemblies. In other embodiments, the trailer may not include any slide out assemblies. In the embodiment of FIG. 2, the travel trailer 200 may include at least one slide out assembly 212. As shown, the slide out assembly 212 is shown in an open or at least partially open position. In this position, the slide out assembly 212 is extended or moved outwardly away from the side wall 206. As is known in the art, moving the slide out assembly 212 to an open position may create additional living space in the interior of the travel trailer 200. This is advantageous in that more space is provided so that more people can occupy the interior of the travel trailer 200.

The slide out assembly 212 may also be positioned in a closed position. In this position, the slide out assembly 212 is retracted or moved inwardly towards the side wall 206. As is known in the art, moving the slide out assembly 212 to a closed position may condense the travel trailer 200 to make transportation and storage of the travel trailer 200 easier.

Referring to the slide out assembly 212 of FIG. 2, the slide out assembly 212 may include an outer wall 214. The outer wall 214 may be formed of a fiberglass material. Other materials may be used for slide out assemblies and the present disclosure is not limited to a fiberglass wall of the slide out assembly.

In several embodiments, the slide out assembly 212 may include one or more windows. In FIG. 2, for example, the slide out assembly 212 may include a first window 216 and a second window 218. Additional windows may be provided. In other embodiments, the slide out assembly 212 may not include any windows.

In FIG. 2, the travel trailer 200 may include a seal assembly. In this embodiment, the seal assembly is shown having an upper seal assembly 228, a first side seal assembly 230, and a second side seal assembly 232.

The present disclosure contemplates an improvement to the slide out pan for a cheaper and easier way to change the pan assembly or components of the pan assembly. This allows for replacement of a support member of the pan assembly, for example a wear bar or a roller, to be changed or replaced without the need to replace the entire pan assembly. Additionally, this allows for the support member of the pan assembly to easily be changed to a better suited support member, such as a wear bar or a roller of a different size, shape, material, and the like. Furthermore, the present disclosure contemplates an improvement to the slide out pan assembly for a better water, debris, and light control. This allows for fewer parts to be used to help prevent fluid, for example, water, debris, and light from entering the trailer.

Here, the travel trailer 200 of FIG. 2 may include a universal slide out pan 234 at or adjacent to a lower trim member 222. Water or ice that flows downwardly may reach the universal slide out pan 234 and be directed by the shape of the universal slide out pan 234 out of the trailer 200. The universal slide out pan 234 is advantageous over conventional slide out and travel trailers which do not provide a means for easily dispensing water, dirt, debris and other contaminants from the area of the seal assembly. Instead, conventional seal assemblies may be structured such that water, dirt, dust, debris or other contaminants may remain and otherwise interfere with the seal assembly.

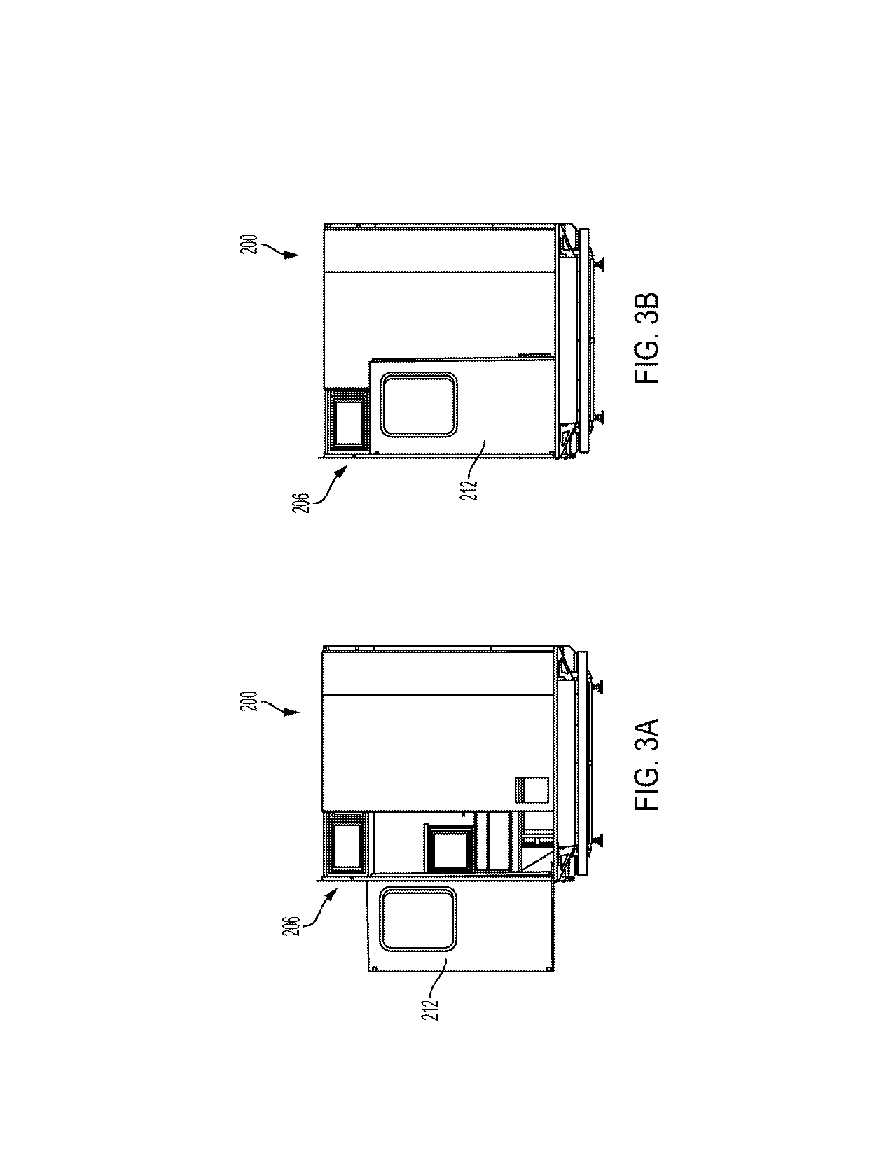

Turning to FIGS. 3A and 3B of the present disclosure, the slide out assembly 212 of the travel trailer 200 is shown in greater detail. As shown in FIG. 3A, the slide out assembly 212 may be in the open or at least partially open position. As shown in FIG. 3B, the slide out assembly 212 may be in the closed position. Specifically with respect to the slide out assembly 212, the slide out assembly 212 may be extended and retracted via one or more cables (not shown) in one embodiment. In another embodiment, the slide out assembly 212 may be actuated between the open position and the closed position via one or more actuators. In one example, the one or more actuators may be a linear actuator. In another example, the one or more actuators may be a mechanical actuator. In a further example, the one or more actuators may be an electric actuator. In yet another example, the one or more actuators may be a hydraulic actuator. In yet further examples, other types of actuators may be used to move the slide out assembly 212 relative to the outer wall 206 of the trailer 200. Moreover, there may be other drive systems beyond cables and actuators that may move the slide out assembly 212 between its open and closed positions, and the present disclosure is not limited to any type of drive system.

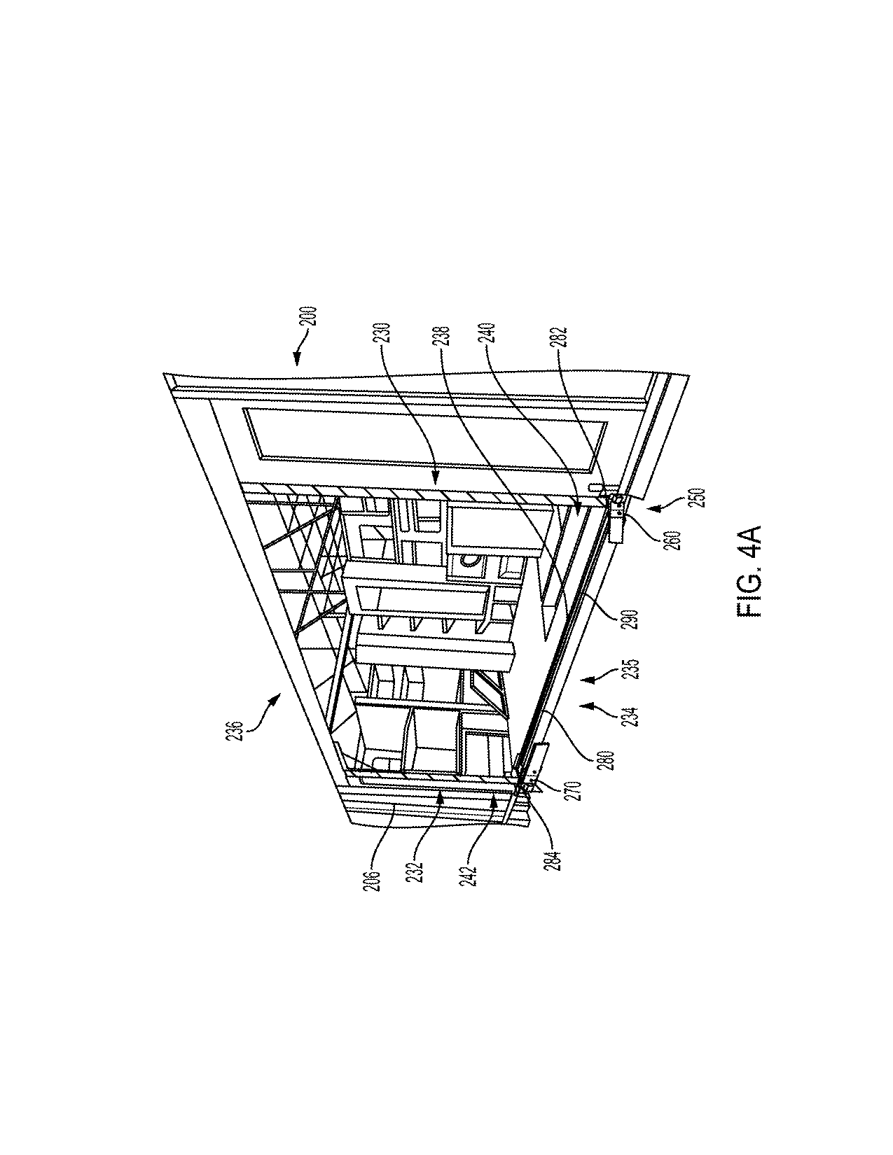

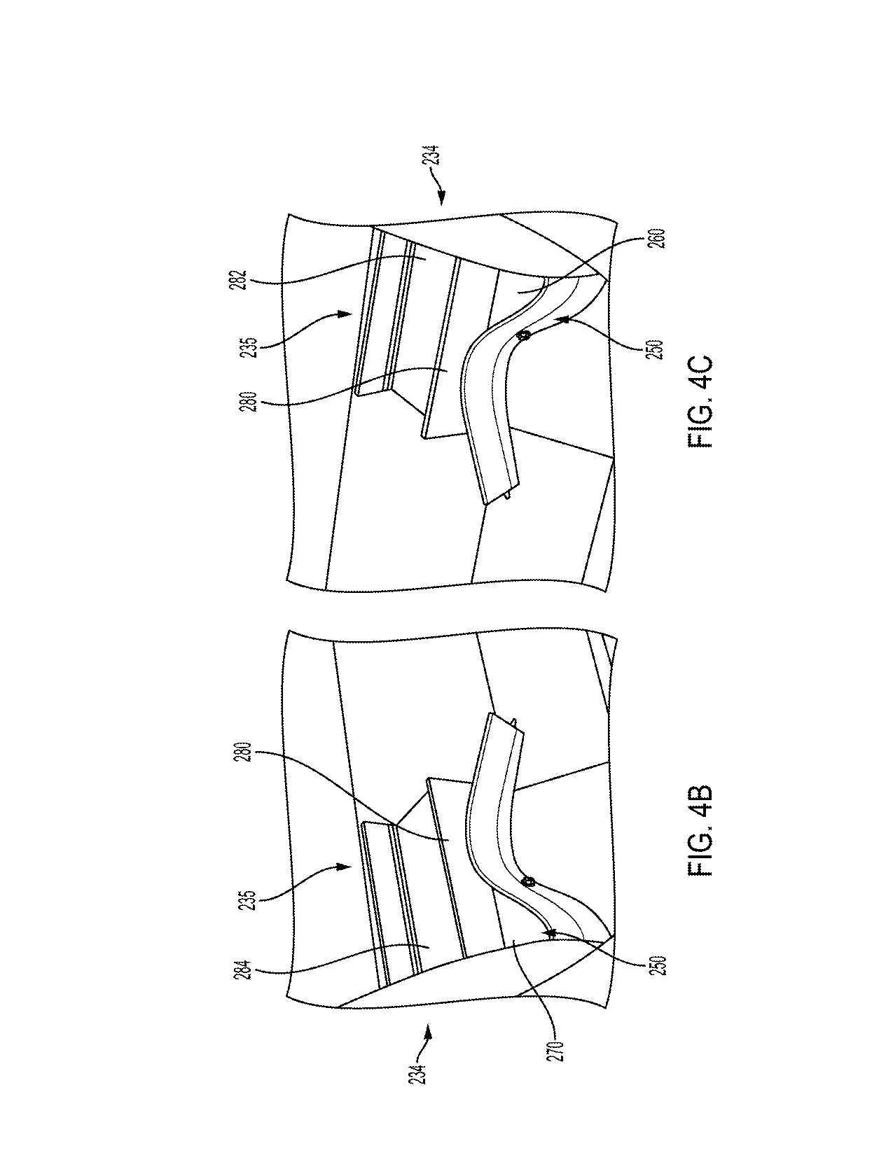

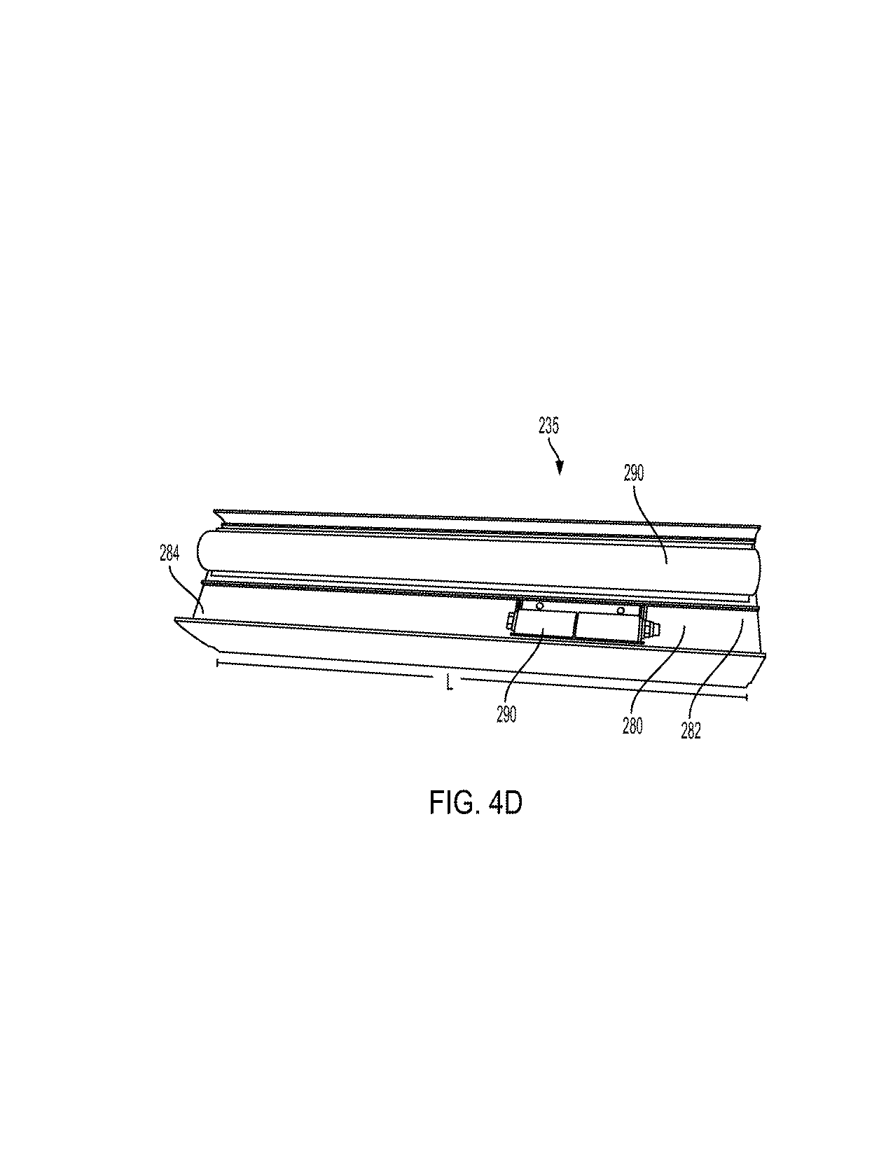

Referring to FIGS. 4A-4C, one embodiment of the universal slide out pan 234 of trailer 200 is shown in greater detail. The universal slide out pan 234 may include a pan assembly 235. The pan assembly 235 may be positioned adjacent an opening 236 in the side wall 206 of the trailer 200. The side wall 206 may form the opening 236. In some embodiments, the pan assembly 235 may be positioned at or on a lower edge 238 of the side wall 206 of the trailer 200, wherein the lower edge 238 at least partially defines the opening 236.

The universal slide out pan 234 may further include a drip cup assembly 250. The drip cup assembly 250 may be positioned adjacent the opening 236 in the side wall 206. For example, in some embodiments the drip cup assembly 250 may be positioned at a first corner 240 and a second corner 242 of the lower edge 238. The drip cup assembly 250 may further be coupled to the trailer 200. More specifically, the drip cup assembly 250 may be coupled to the lower edge 238, for example via one or more fasteners. Additionally or alternatively, the drip cup assembly 250 may be coupled to the lower edge 238 with an adhesive..

As shown in FIG. 4A, a first drip cup 260 may be positioned along the lower edge 238. More specifically, the first drip cup 260 may be positioned and coupled to the first corner 240. Similarly, a second drip cup 270 may be positioned along the lower edge 238. More specifically, the second drip cup 270 may be positioned and coupled to the second corner 242 of the lower edge 238 in the side wall 206.

In some embodiments, the first seal assembly 230 may be positioned near the drip cup assembly 250. In some embodiments, the drip cup assembly 250 may at least partially surround the first seal assembly 230. More specifically, the first drip cup 260 may at least partially surround the first seal assembly 230. Therefore, any water, ice, or other contaminants that run off from the seal assembly may be accumulated and egressed by the drip cup assembly 250. In other words, water, ice, or other contaminants may drip from the seal assembly into the drip cup assembly 250 and may be egressed outside of the trailer 200. In some embodiments, the second seal assembly 232 may be positioned near the drip cup assembly 250. Similarly as described with respect to the first seal assembly 230, the drip cup assembly 250 may at least partially surround the second seal assembly 232. More specifically, the second drip cup 270 of the drip cup assembly 250 may at least partially surround the second seal assembly 232. As mentioned above, this orientation is advantageous to direct water, ice, or other contaminants outside the trailer 200.

Referring to FIG. 4D, the pan assembly 235 includes a pan 280 with a length L. The length L may be defined as the distance between a first end 282 of the pan 280 and a second end 284 of the pan 280. In some embodiments, the pan 280 may be at least partially positioned on the drip cup assembly 250. For example, the first end 282 and the second end 284 of the pan 280 may be at least partially positioned on the drip cup assembly 250. In some embodiments, the pan 280 may be at least partially positioned above the drip cup assembly 250 to facilitate a removal of fluid from the pan 280. The pan 280 may be coupled to the trailer 200, for example to the lower edge 238. In some embodiments, the pan 280 may be coupled to the trailer 200 for via one or more fasteners. Additionally, or alternatively, the pan 280 may be coupled to the trailer 200 via an adhesive. In certain forms, the pan 280 may be coupled to the drip cup assembly 250, for example via one or more fasteners. Additionally, or alternatively, the pan 280 may be coupled to the drip cup assembly 250 via an adhesive. However, in some embodiments, the pan 280 may not be coupled to the drip cup assembly 250.

While the illustrated embodiment of FIGS. 4B and 4C only illustrates a portion of the pan 280, it should be understood that the pan 280 may extend along the lower edge 238 between the first drip cup 260 and the second drip cup 270 as shown in FIG. 4A.

The pan assembly 235 further includes one or more support members 290. In certain forms, the one or more support members 290 may be one or more wear bars. In certain forms, the one or more support members 290 may be one or more rollers. In certain embodiments, the one or more support members 290 may be a combination of one or more wear bars and one or more rollers. The one or more support members may have sufficient structural integrity and may be configured to support the slide out assembly 212, for example when extending and retracting between the open, partially open, and closed positions. Additionally, the one or more support members 290 may be configured to guide the slide out assembly when extending and retracting between the open, partially open, and closed positions.

In some embodiments, the one or more support members may be one or more wear bars. The one or more wear bars may be coupled to the pan as described herein. In some embodiments, the one or more wear bars are removably coupled to the pan. This is advantageous as it allows for the same pan to be used, for example an existing pan mounted to the trailer, while being able to select from a variety of different wear bars, as described herein. Different height wear bars may be used for different applications, for example, to achieve maximum support for the slide out assembly and/or cost.

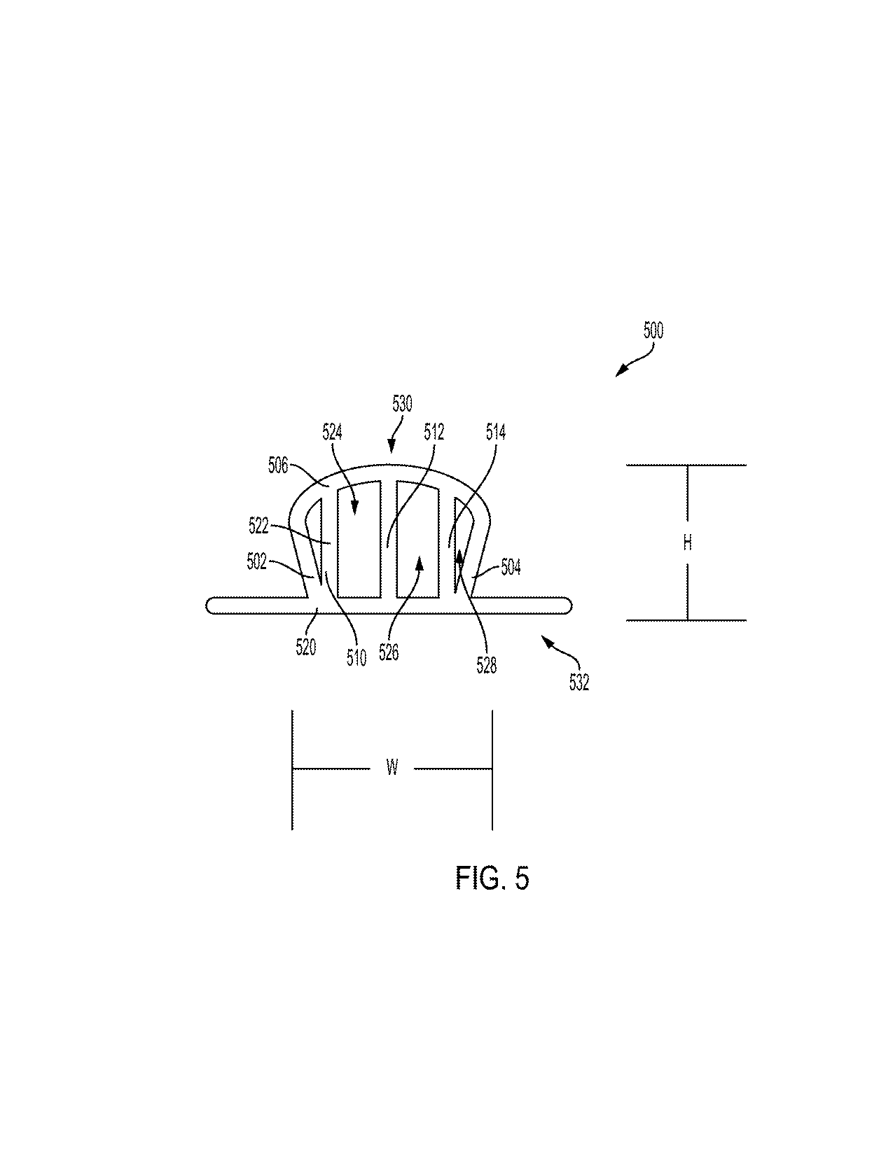

The one or more wear bars may extend at least the length L of the pan. In other forms, the one or more wear bars may not extend the length L of the pan, for example the one or more wear bars may extend more than the length L. In some embodiments, the one or more wear bars may extend less than the length L. The one or more wear bars are configured to at least partially hold the weight of the slide out assembly when the slide out assembly. The one or more wear bars may help support the slide out assembly and help guide the slide out assembly when extending and retracting between the open, partially open, and closed positions. The slide out assembly is configured to extend and retract by sliding across the one or more wear bars. The one or more wear bars may have sufficient structural integrity to serve as a support and guide. The one or more wear bars may have a cross sectional area as shown in FIG. 5.

FIG. 5 illustrates a support member 500. In some embodiments, the support member 500 may substitute one or more of the support members 290 in pan assembly 235. The support member 500 is in the form of a wear bar. However, it should be understood that any other wear bar known in the art may be used in the pan assembly 235.

The support member 500 may include a first wall 502, a second wall 504, and a connecting wall 506. The connecting wall 506 may be connected to the first wall 502 and the second wall 504. In some embodiments, the first wall 502, the second wall 504, and the connecting wall 506 may be formed as one integral piece.

The support member may further include one or more protruding members. For example, as shown in FIG. 5, the support member 500 includes a first protruding member 510, a second protruding member 512, and a third protruding member 514. The protruding members 510, 512, and 514 may support the connecting wall 506 and ultimately to support the slide out assembly.

The first protruding member 510 may be coupled to or protrude from a base 520 of the support member 500 and coupled to the connecting wall 506, thus creating a first cavity 522 at least partially defined by the first protruding member 510, part of the connecting wall 506, and the first wall 502. In certain forms, the first cavity 522 may at least be defined by the base 520, the first protruding member 510, part of the connecting wall 506, and the first wall 502. The second protruding member 512 may be coupled to or protrude from the base 520 and may be coupled to the connecting wall 506. A second cavity 524 may be formed and at least partially defined by the first protruding member 510, part of the connecting wall 506, the second protruding member 512, and part of the base 520. The third protruding member 514 may be coupled to or protrude from the base 520 and coupled to the connecting wall 506. A third cavity 526 may be formed and at least partially defined by the second protruding member 512, part of the connecting wall 506, the third protruding member 514, and part of the base 520. A fourth cavity 528 may be formed and at least partially defined by the third protruding member 514, part of the connecting wall 506, and the second wall 504. In certain forms, the fourth cavity 528 may be at least partially defined by the third protruding member 514, part of the connecting wall 506, the second wall 504, and part of the base 520.

The support member 500 may have a height H and a width W. The height H may be defined as the distance between the connecting wall 506 and the base 520, for example the distance between a vertex or apex 530 of the connecting wall 506 and an outer surface 532 of the base 520. The width W may be defined as the distance between the first wall 502 and the second wall 504.

In some embodiments, the support member 500 may have a height H that is between 0.4 inches and 0.7 inches, for example, 0.58 inches. In some embodiments, the support member 500 may have a height H that is between 0.65 inches and 0.95 inches, for example 0.83 inches. In some embodiments, the support member 500 may have a height H that is between 0.9 inches and 1.1 inches, for example 1.08 inches. The width W may be sized accordingly to fit on the pan. In some embodiments, the width W may be between 0.5 inches and 1.5 inches. In some embodiments, the width W may be between 0.75 inches and 1.25 inches, for example around 1 inch. However, the width W may fall outside of these ranges to fit better on the pan and/or to better support the slide out assembly.

In some embodiments, the support member 500 may be made of a plastic material, for example polypropylene. In certain forms, the support member 500 may be made of high impact polypropylene. The support member being made of high impact polypropylene provides the support member with sufficient structural integrity to serve both as a support and a guide to the slide out assembly. However, the support member 500 may be made of any material that has sufficient fatigue resistance, or in other words that may support and help guide a slide out assembly without wearing out quickly.

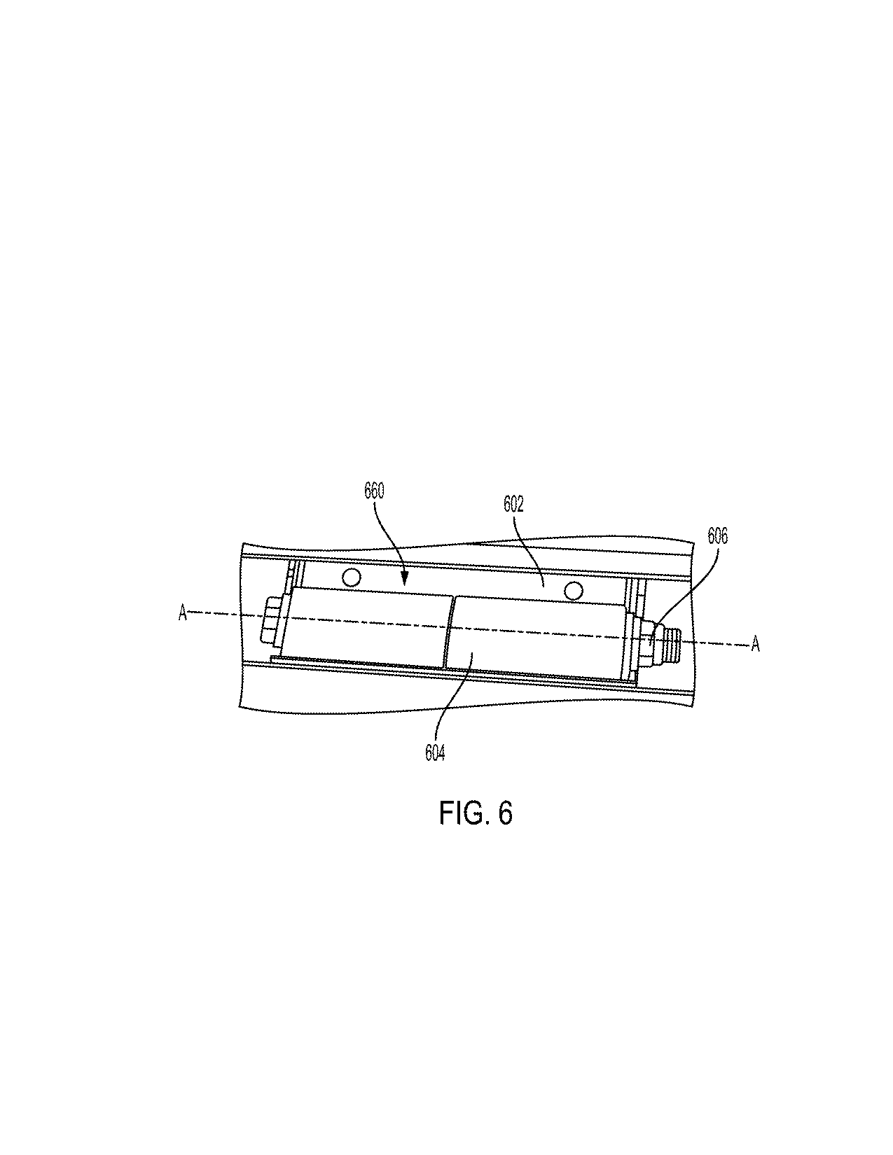

FIG. 6 illustrates a support member 600. The support member 600 may substitute one or more of the support members 290 in the pan assembly 235. The support member 600 is in the form of a roller. While one embodiment of a roller is shown in FIG. 6, any known roller may be used as the support member. In some embodiments, the one or more rollers are removably coupled to the pan. This is advantageous as it allows for the same pan to be used, for example an existing pan mounted to the trailer, while being able to select from a variety of different rollers such as rollers with different heights, widths, load capacity, and the like. The support member 600 may include a base 602 and a body 604. The body 604 may be rotatably coupled to the base 602. More specifically, the body 604 may be rotatably coupled to the base 602 by a rod or pin 606. The body 604 is configured to rotate about an axis A extending through the center of the rod or pin 606. In other words, the body 604 may rotate about the rod or pin 606. The body 604 may be generally cylindrical in shape.

The support member 600 is configured to support the slide out assembly, for example when extending and retracting between the open, partially open, and closed positions. Additionally, the support member 600 is configured to help guide the slide out assembly when extending and retracting between the open, partially open, and closed positions. The slide out assembly is configured to extend and retract by rolling across the support member 600.

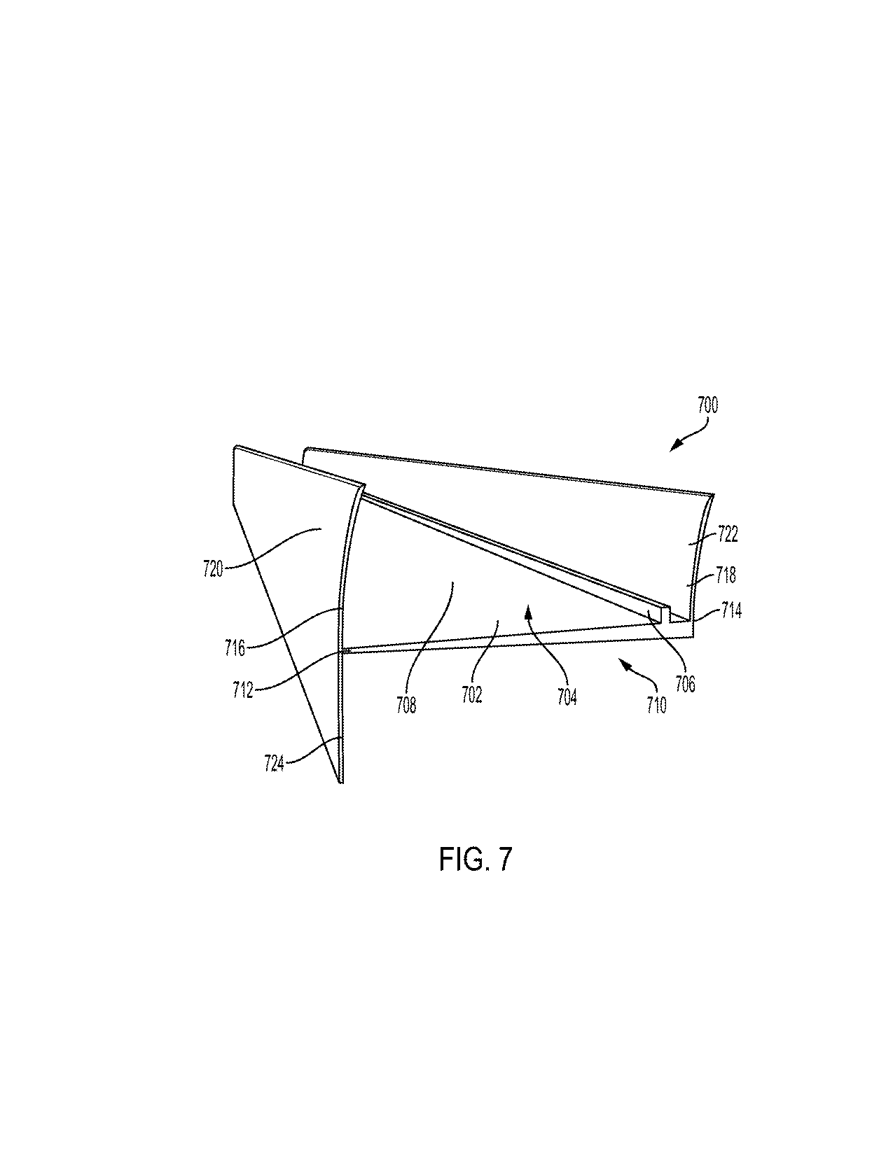

Referring to FIG. 7, a pan 700 is illustrated. In some embodiments, the pan 700 may substitute the pan 280 in the pan assembly 235. The pan 700 includes a pan body 702, a first attachment section 704, and a first protrusion 706. The pan body 702 may include a first edge 712 and a second edge 714. The first protrusion 706 may extend from the pan body 702. More specifically, the first protrusion 706 may extend from a first surface 708 of the pan body 702. The pan body 702 may also have a second surface 710, the second surface 710 generally opposite the first surface 708. The first attachment section 704 may be positioned between the first edge 712 of the pan and the second edge 714 of the pan body 702. The first attachment section 704 may be at least partially defined by the first surface 708. The first protrusion 706 may extend from the first surface 708 of the pan body 702 between the first attachment section 704 and the second edge 714. The first protrusion 706 may indicate the placement of one or more support members, for example a wear bar and/or a roller, on the pan. The one or more support members may be positioned adjacent the first protrusion 706, for example the one or more support members may be touching the first protrusion 706.

As shown in FIGS. 7-9B, the first surface 708 may be sloped from the first edge 712 of the pan body 702 to the second edge 714 of the pan body 702, for example, sloped downwardly from the first edge 712 to the second edge 714. In some embodiments, the first surface 708 of the pan may be angled relative to the second surface 710 of the pan body 702 by an angle ϴ₁. In some embodiments, ϴ₁ may be between 0° and 20°. In some examples, ϴ₁ may be between 5° and 15°, for example 10°. Therefore, a first edge thickness T₁ may be less than a second edge thickness T₂. The first edge 712 may be positioned towards the exterior of the trailer. The pan 700 being sloped allows fluid, for example, water, ice, or other contaminants that have been captured by the pan assembly to run towards the first edge 712 of the pan. In some embodiments, the pan 700 may not be sloped. In some embodiments, the first surface 708 of the pan body may not be angled relative to the second surface 710 of the pan body. Therefore, the first edge thickness T₁ may be equal to the second edge thickness T₂.

The pan 700 may further include a first lip 716. The first lip 716 may be coupled to the first edge 712 of the pan 700. The first lip 716 may be formed integrally with the pan body 702. In some embodiments, the first lip 716 may extend from the first edge 712 in a first direction D1 generally traverse to the second surface 710 of the pan body 702. In some embodiments, the first lip 716 may extend the entire length L of the pan 700. In other embodiments, the first lip 716 may not extend the entire length L of the pan.

In some embodiments, the pan 700 may further include a second lip 718. The second lip 718 may be coupled to the second edge 714 of the pan body 702. The second lip 718 may be formed integrally with the pan body 702. In certain forms, the second lip 718 may extend from the second edge 714 of the pan in the first direction D1. In some embodiments, the second lip 718 may extend the entire length L of the pan. In other embodiments, the second lip 718 may not extend the entire length L of the pan.

The pan 700 further includes a first wipe 720. The first wipe 720 may be coupled to the first lip 716. In some embodiments, the first wipe 720 may be formed integrally with the first lip 716. The first wipe 720 may be sized accordingly to block light, for example the sun, from entering the trailer through any gaps between the slide out assembly and the lower edge of the opening formed by the side wall. Additionally or alternatively, the first wipe 720 may be sized accordingly to prevent debris from entering the trailer, for example, the interior of the trailer, through any gaps between the slide out assembly and the lower edge in the side wall, wherein the lower edge at least partially defines the opening in the side wall. In certain forms, the first wipe 720 may extend at least the length L of the pan. In other forms, the first wipe 720 may not extend the length L of the pan. In certain forms the first wipe 720 and the first lip 716 may be formed from the same material and/or may be formed as one integral piece. The first wipe may 720 be made of a material that is flexible. The first wipe 720 may be configured to bend as the slide out assembly extends and retracts.

In some embodiments, the pan 700 may further include a second wipe 722. The second wipe 722 may be coupled to the second lip 718. In some embodiments, the second wipe 722 may be formed integrally with the second lip 718. The second wipe 722 may be sized accordingly to block light, for example the sun, from entering the trailer 200 through any gaps between the slide out assembly and the lower edge in the side wall. Additionally or alternatively, the second wipe 722 may be sized accordingly to prevent debris from entering the trailer 200 through any gaps between the slide out assembly and the lower edge in the side wall. In certain forms, the second wipe 722 may extend at least the length L of the pan. In other forms, the second wipe 722 may not extend the length L of the pan. In certain forms, the second wipe 722 and the second lip 718 may be formed from the same material. The second wipe 722 may be made of a material that is flexible. The second wipe 722 may be configured to bend as the slide out assembly extends and retracts.

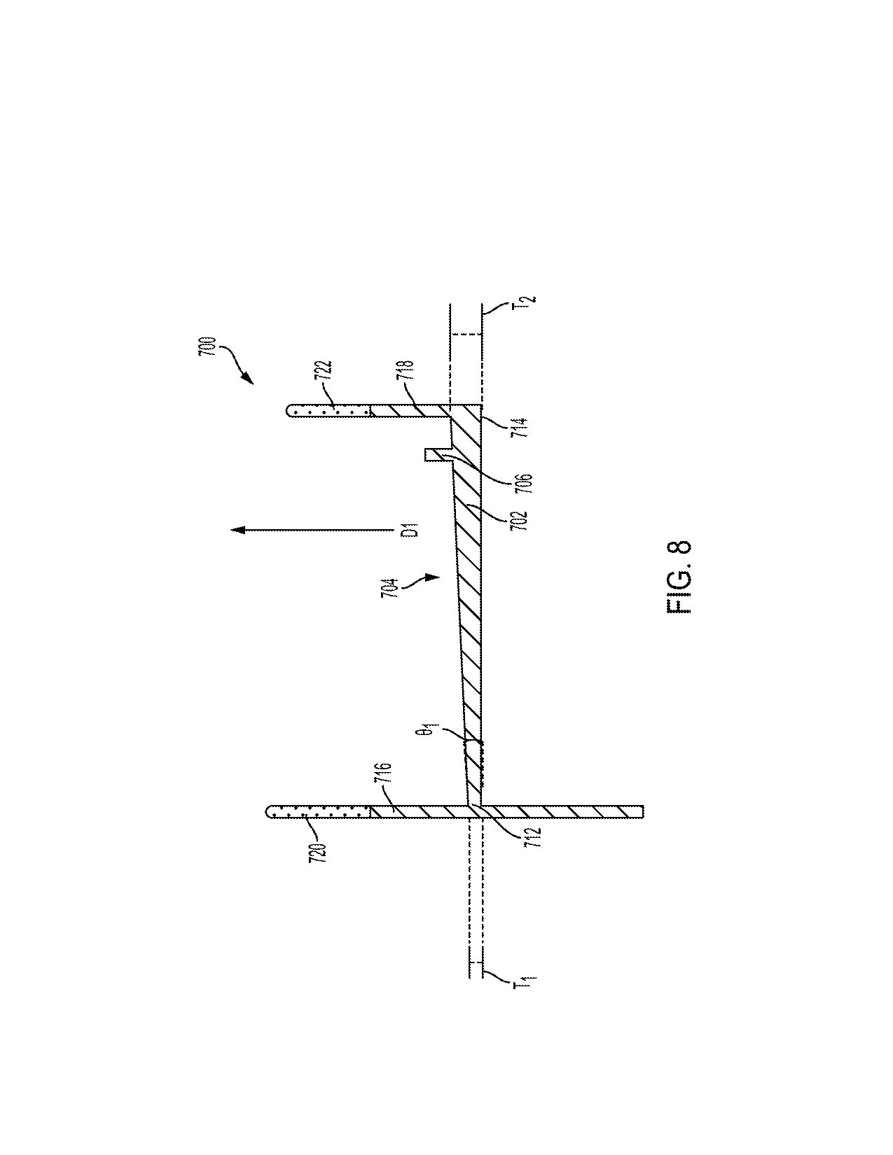

In certain embodiments, the pan 700 may also include a first member 724. The first member 724 may be coupled to the first edge 712 of the pan body 702. The first member 724 may extend from the first edge 712 in a direction generally opposite the first direction D1. In certain forms, the first member 724 and the pan body 702 may be one integral piece. Additionally or alternatively, the first lip 716 and the first member 724 may be formed as one integral piece. As shown in FIG. 8, the pan 700 may generally have an “h” or upside-down “h” cross sectional shape to it.

The pan 700 may be positioned on an edge of an opening formed by a side wall of a travel trailer. For example, the second surface 710 may be positioned on the edge of the opening formed by the side wall.

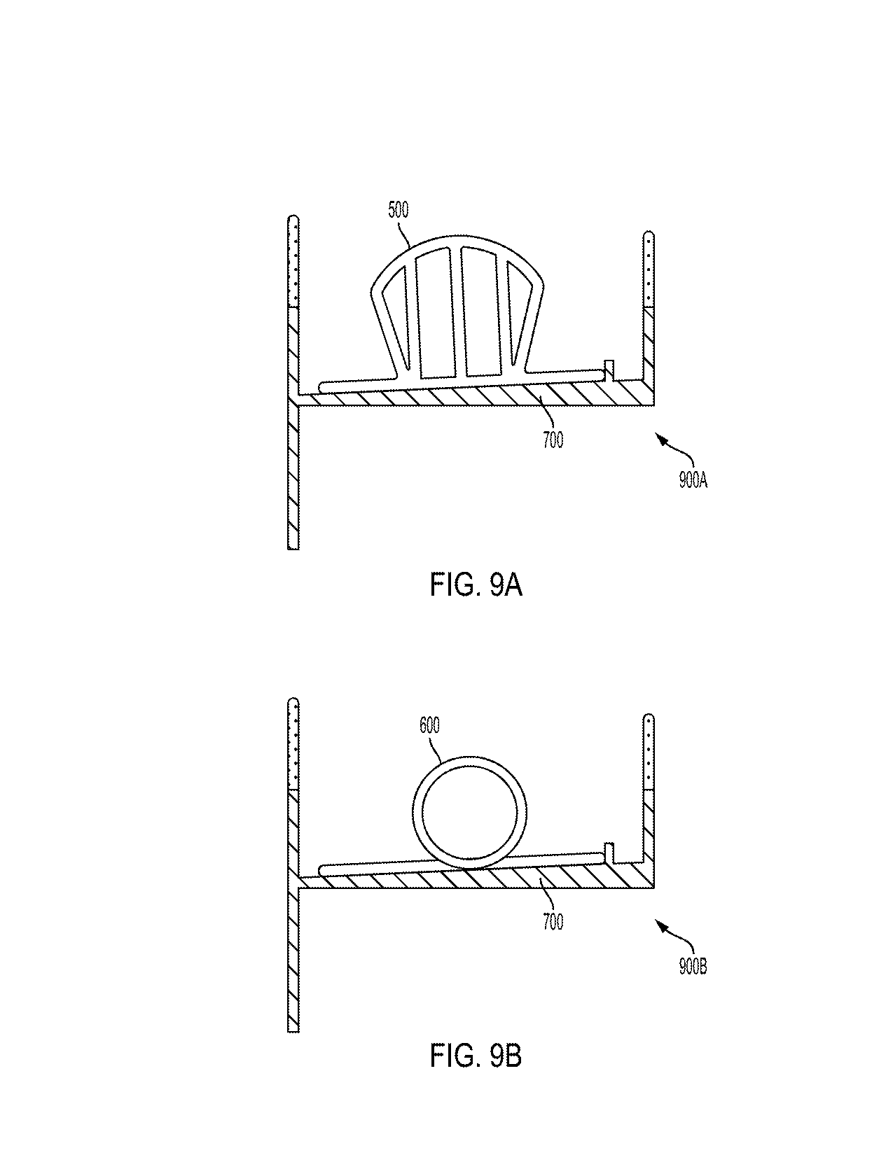

Now referring to FIG. 9A, a pan assembly 900A is illustrated. In some embodiments, the pan assembly 900A may be used to substitute the pan assembly 235. The pan assembly 900A includes the pan 700, and the support member 500. The support member 500 may be coupled to the pan 700. More specifically, the support member 500 may be removably coupled to the first surface 708 of the pan body 702, for example, on the first attachment section 704.

Referring to FIG. 9B, the pan assembly 900B is illustrated. In some embodiments, the pan assembly 900B may be used to substitute the pan assembly 235. The pan assembly 900B may include the pan 700 and at least one support member 600. The at least one support member 600 may be coupled to the pan 700. More specifically, the at least one support member 600 may be removably coupled to the first surface 708 of the pan body 702, for example, on the first attachment section 704. It should be understood that more than support member 600 may be coupled to the pan 700, for example along the first attachment section 704.

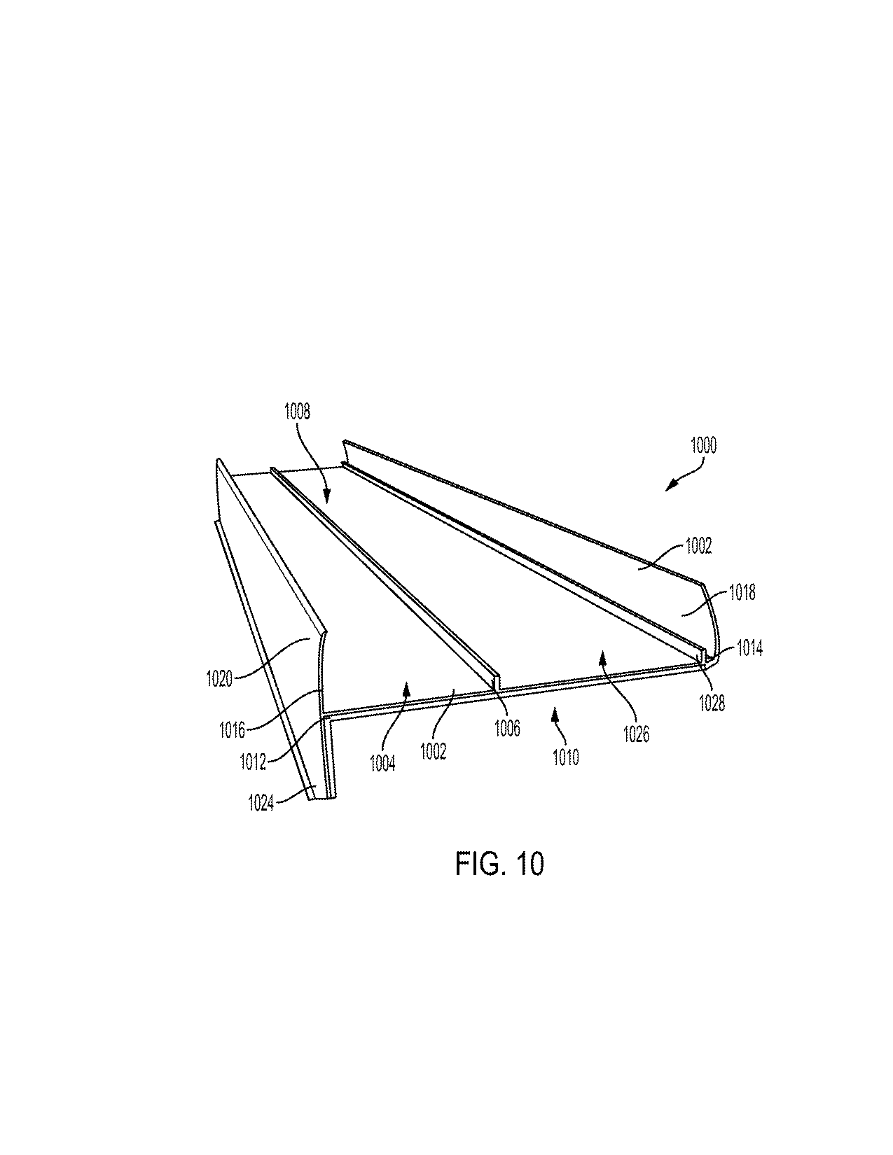

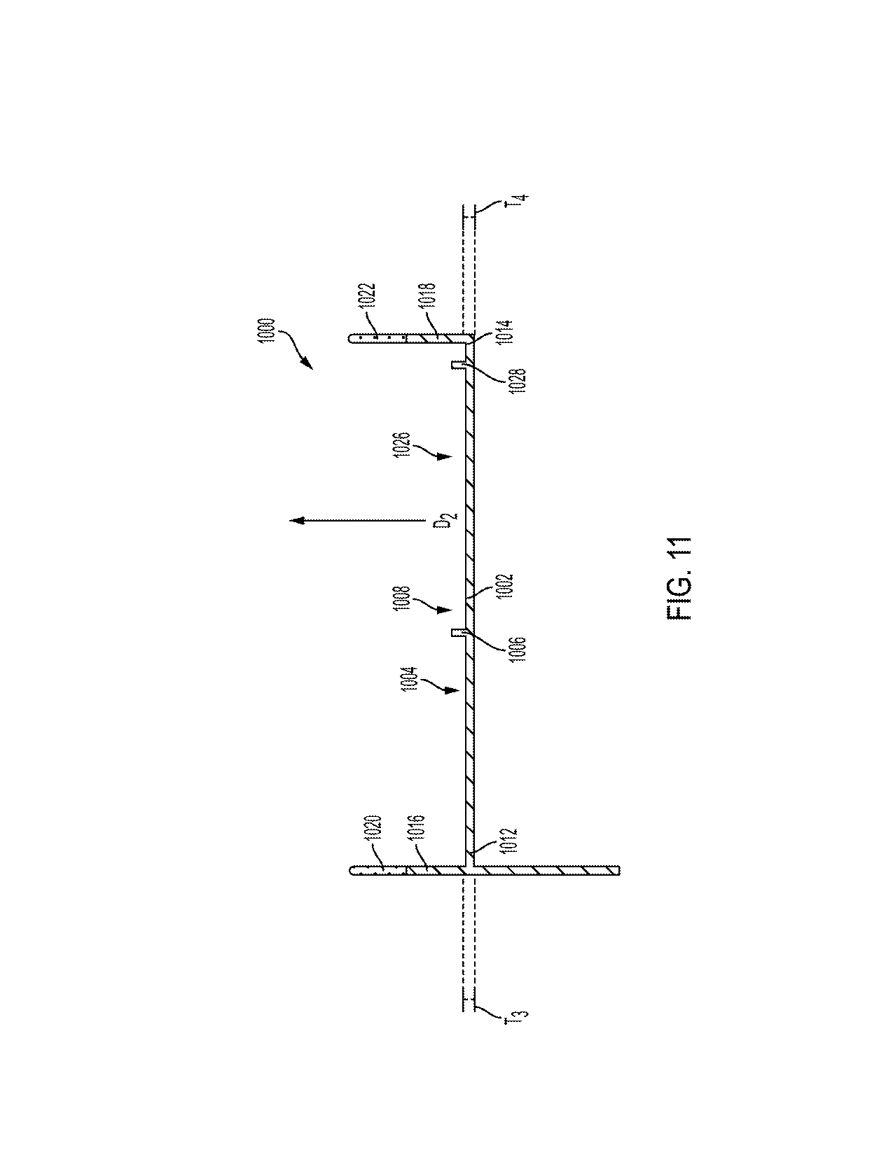

Now referring to FIGS. 10-11, a pan 1000 is illustrated. The pan 1000 may include features similar to those disclosed with respect to pan 700. In some embodiments, the pan 1000 may substitute the pan 280 in the pan assembly 235. The pan 1000 may include a pan body 1002, a first attachment section 1004, a first lip 1016, a second lip 1018, a first wipe 1020, a second wipe 1022, and a first member 1024. The pan body 1002 may have a first surface 1008 and a second surface 1010, the first surface 1008 generally opposite the second surface 1010. The pan body may have a first edge 1012 with a first edge thickness T₃ and a second edge 1014 with a second edge thickness T₄. As shown in FIG. 11, the pan 1000 may generally have an “h” or upside-down “h” shape to it. In some embodiments, the pan body 1002 may be flat. In some embodiments, the first surface 1008 of the pan body may not be angled relative to the second surface 1010 of the pan body 1002. Therefore, the first edge thickness T₃ may be equal to the second edge thickness T₄. In other embodiments, the first surface 1008 may be sloped between the first edge 1012 and the second edge 1014. In some embodiments, the first surface 1008 of the pan body 1002 may be angled relative to the second surface 1010 of the pan body 1002. In some embodiments, the first surface 1008 may be angled relative to the second surface 1010 between 0° and 20°. In some examples, the first surface 1008 may be angled relative to the second surface 1010 between 5° and 15°, for example 10°. Therefore, in some embodiments the first thickness T₃ may be greater than or less than the second thickness T₄.

The pan 1000 may further include a second attachment section 1026. The pan may include a second protrusion 1028. The second protrusion 1028 may extend from the pan body 1002. More specifically, the second protrusion 1028 may extend from a first surface 1008 of the pan body 1002 in a first direction D2. As shown in FIG. 11. the first attachment section 1004 and the second attachment section 1026 may be positioned between the first edge 1012 of the pan body 1002 and the second edge 1014 of the pan body 1002. The first protrusion 1006 may extend from the first surface 1008 of the pan body 1002 between the first attachment section 1004 and the second attachment section 1026. The second protrusion 1028 may extend from the first surface 1008 of the pan body 1002 between the second attachment section 1026 and the second edge 1014 of the pan body 1002. The first protrusion 1006 and the second protrusion 1028 may indicate placement positions of where one or more support members, for example one or more wear bars and/or one or more rollers, may be positioned on the pan. The one or more support members may be positioned adjacent the first protrusion 1006, for example the one or more support members may be touching the first protrusion 1006. In certain forms, the one or more support members may be positioned adjacent the second protrusion 1028, for example the one or more support members may be touching the second protrusion 1028. In some embodiments, a first support member may be positioned adjacent the first protrusion 1006, for example touching the first protrusion, and a second support member may be positioned adjacent the second protrusion 1028, for example touching the second protrusion 1028.

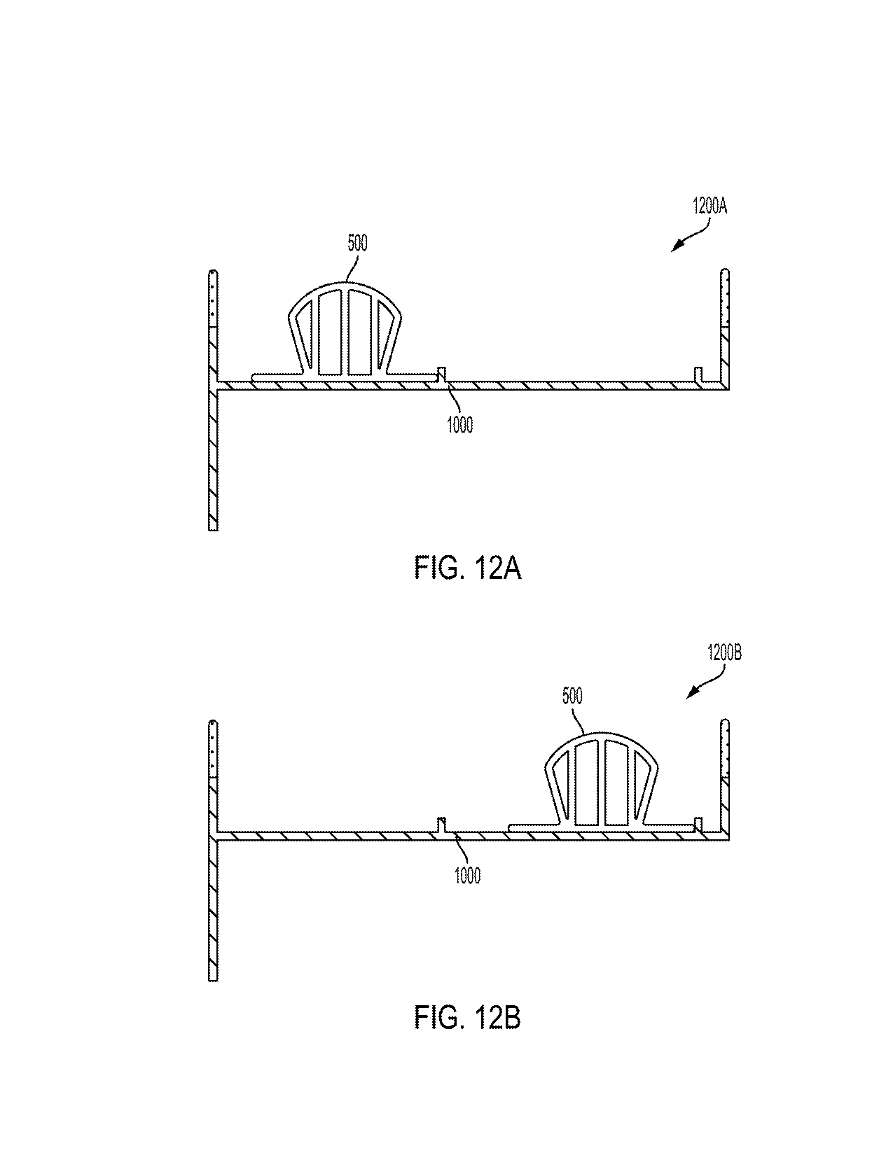

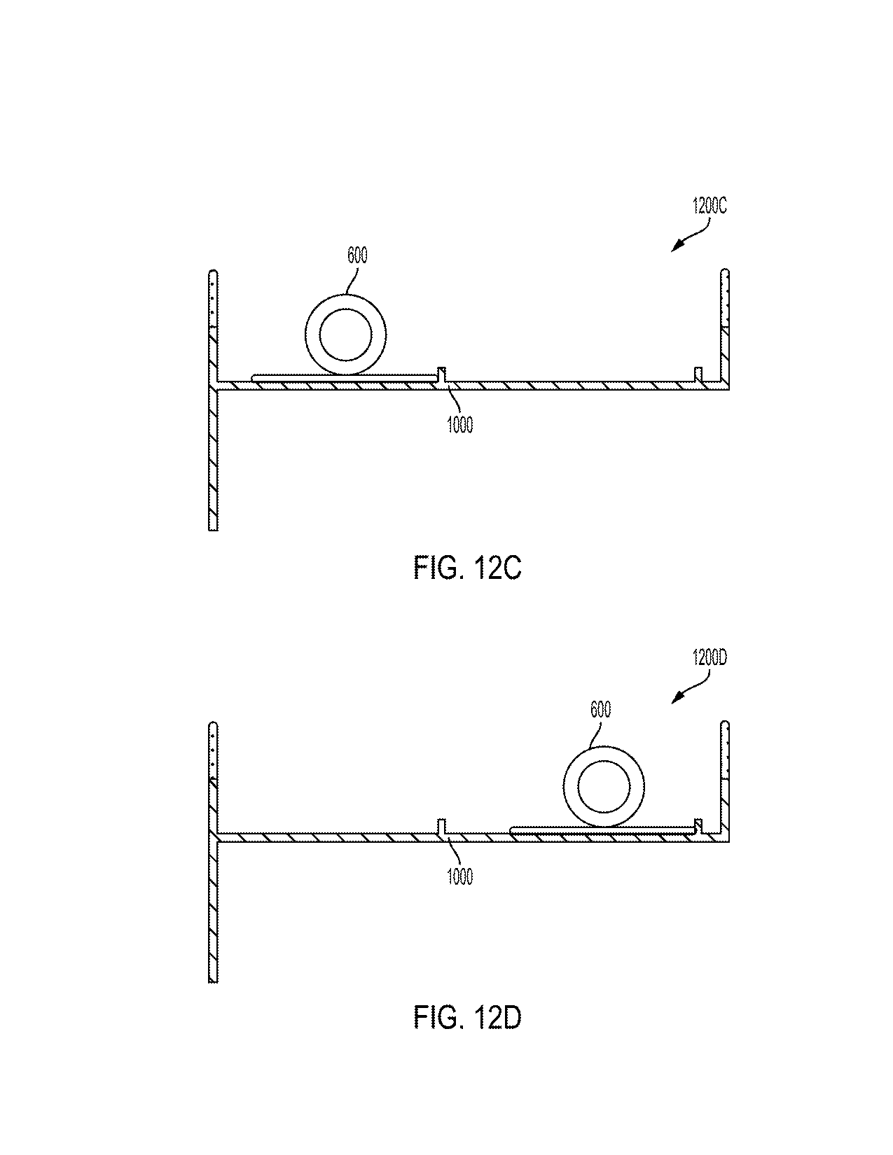

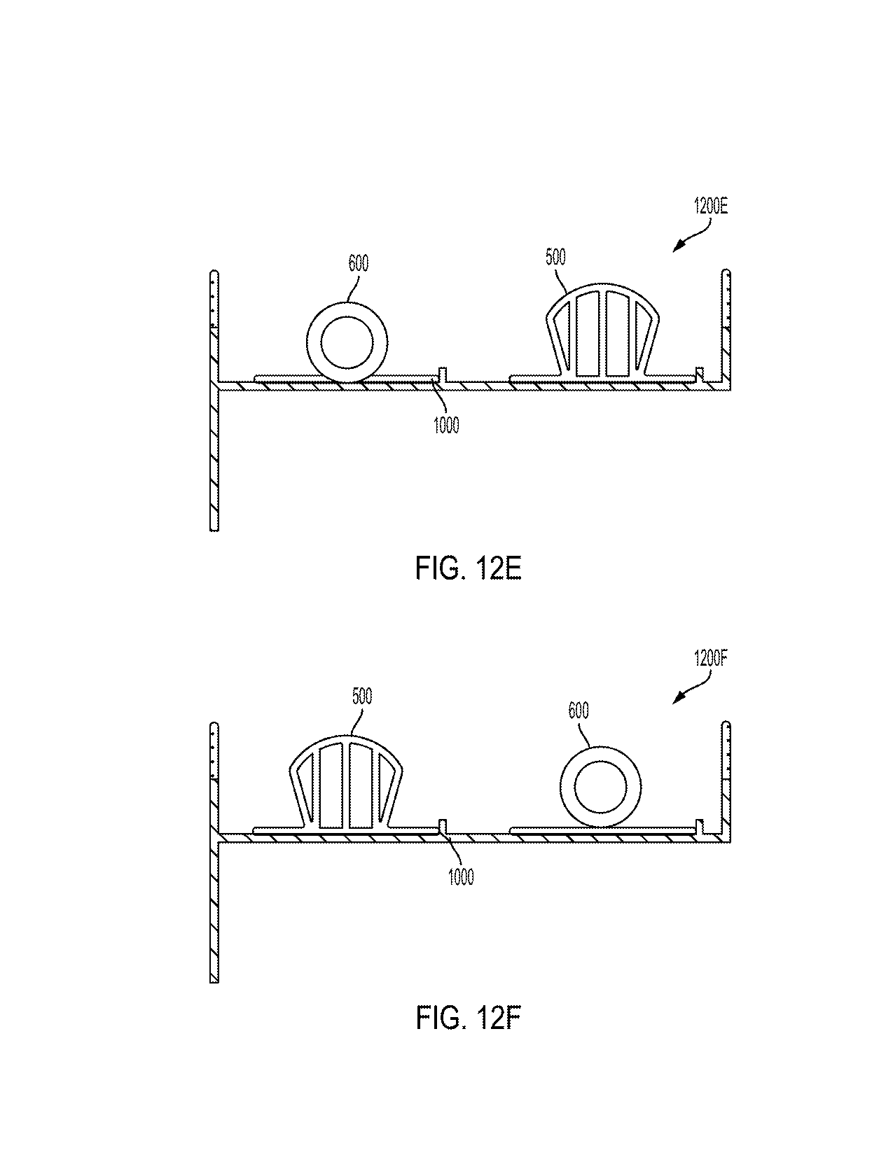

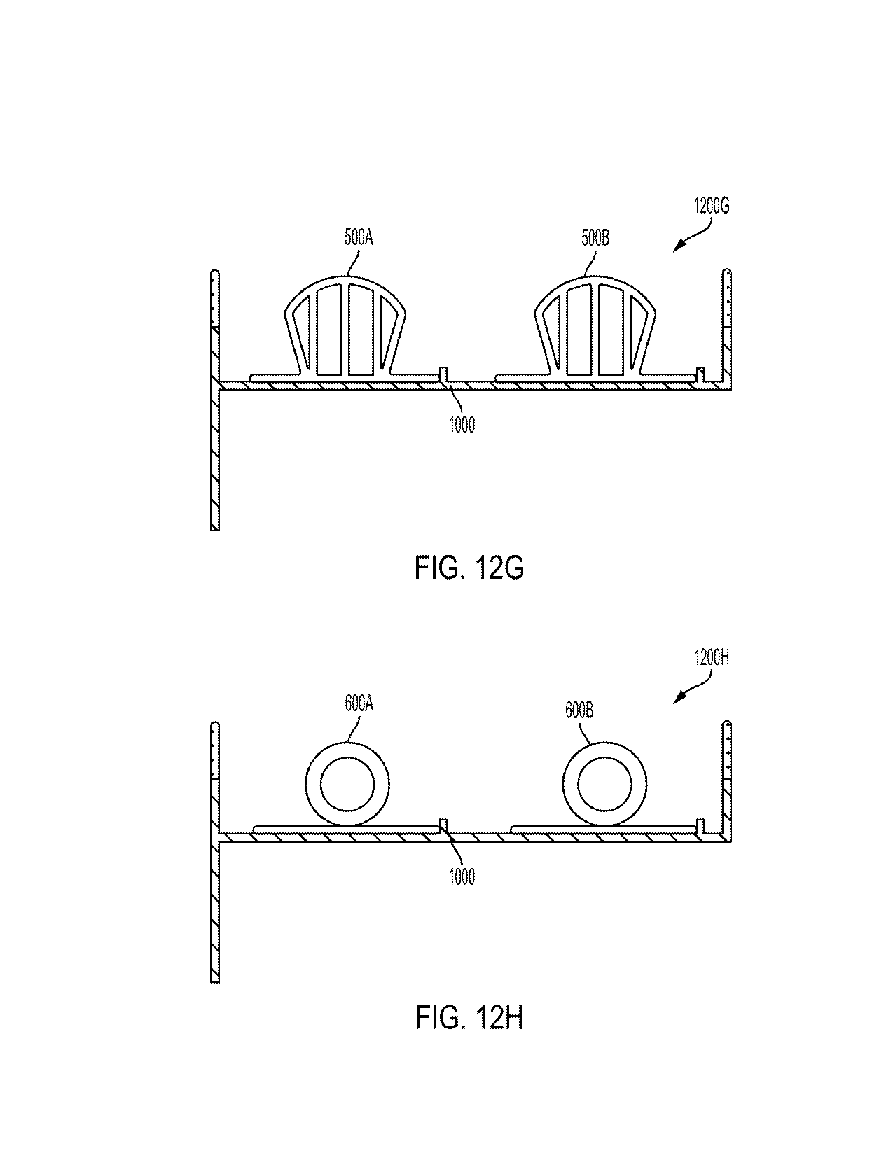

Referring to FIG. 12A, a pan assembly 1200A is illustrated. In some embodiments, the pan assembly 1200A may be used to substitute the pan assembly 235. The pan assembly 1200A may include the pan 1000 and the support member 500. The support member 500 may be coupled to the pan 1000. More specifically, the support member 500 may be removably coupled to the first surface 1008 of the pan body 1002, for example, on the first attachment section 1004. The second attachment section 1026 may not have a support member attached to it.

Referring to FIG. 12B, a pan assembly 1200B is illustrated. In some embodiments, the pan assembly 1200B may be used to substitute the pan assembly 235. The pan assembly 1200B may include the pan 1000 and the support member 500. The support member 500 may be coupled to the pan 1000. More specifically, the support member 500 may be removably coupled to the first surface 1008 of the pan body 1002, for example, on the second attachment section 1026. The first attachment section 1004 may not have a support member attached to it.

Referring to FIG. 12C, a pan assembly 1200C is illustrated. In some embodiments, the pan assembly 1200C may be used to substitute the pan assembly 235. The pan assembly 1200C may include the pan 1000 and at least one support member 600. The at least one support member 600 may be coupled to the pan 1000. More specifically, the at least one support member 600 may be removably coupled to the first surface 1008 of the pan body 1002, for example, on the first attachment section 1004. The second attachment section 1026 may not have a support member attached to it. It should be understood that more than one support members 600 may be coupled to the pan 1000, for example along the first attachment section 1004.

Referring to FIG. 12D, a pan assembly 1200D is illustrated. In some embodiments, the pan assembly 1200D may be used to substitute the pan assembly 235. The pan assembly 1200D may include the pan 1000 and at least one support member 600. The at least one support member 600 may be coupled to the pan 1000. More specifically, the at least one support member 600 may be removably coupled to the first surface 1008 of the pan body 1002, for example, on the second attachment section 1026. The first attachment section 1004 may not have a support member attached to it. It should be understood that more than one support members 600 may be coupled to the pan 1000, for example along the second attachment section 1026.

Referring to FIGS. 12E, a pan assembly 1200E is illustrated. In some embodiments, the pan assembly 1200E may be used to substitute the pan assembly 235. The pan assembly 1200E may include the pan 1000, the support member 500, and at least one support member 600. The at least support member 600 may be coupled to the pan 1000. More specifically, the at least one support member 600 may be removably coupled to the first surface 1008 of the pan body 1002, for example, on the first attachment section 1004. It should be understood that more than one support member 600 may be coupled to the pan 1000, for example along the first attachment section 1004. The support member 500 may be coupled to the pan 1000. More specifically, the support member 500 may be removably coupled to the first surface 1008 of the pan body 1002, for example, on the second attachment section 1026.

Referring to FIG. 12F, a pan assembly 1200F is illustrated. In some embodiments, the pan assembly 1200F may be used to substitute the pan assembly 235. The pan assembly 1200F may include the pan 1000, the support member 500, and at least one support member 600. The support member 500 may be coupled to the pan 1000. More specifically, the support member 500 may be removably coupled to the first surface 1008 of the pan body 1002, for example, on the first attachment section 1004. The at least support member 600 may be coupled to the pan 1000. More specifically, the at least one support member 600 may be removably coupled to the first surface 1008 of the pan body 1002, for example, on the second attachment section 1026. It should be understood that more than one support member 600 may be coupled to the pan 1000, for example along the second attachment section 1026.

Referring to FIG. 12G, a pan assembly 1200G is illustrated. In some embodiments, the pan assembly 1200G may be used to substitute the pan assembly 235. The pan assembly 1200G may include the pan 1000 and two support members 500A and 500B, which are similar to the support member 500. The support member 500A may be coupled to the pan 1000. More specifically, the support member 500A may be removably coupled to the first surface 1008 of the pan body 1002, for example, on the first attachment section 1004. The support member 500B may be coupled to the pan 1000. More specifically, the support member 500B may be removably coupled to the first surface 1008 of the pan body 1002, for example, on the second attachment section 1026.

Referring to FIG. 12H, a pan assembly 1200H is illustrated. In some embodiments, the pan assembly 1200H may be used to substitute the pan assembly 235. The pan assembly 1200H may include the pan 1000 and at least two support members 600A and 600B, which are similar to the support member 600. The support member 600A may be coupled to the pan 1000. More specifically, the support member 600A may be removably coupled to the first surface 1008 of the pan body 1002, for example, on the first attachment section 1004. It should be understood that more than one support member 600 may be coupled to the pan 1000 along the first attachment section 1004. The support member 600B may be coupled to the pan 1000. More specifically, the support member 600B may be removably coupled to the first surface 1008 of the pan body 1002, for example, on the second attachment section 1026. It should be understood that more than one support member 600 may be coupled to the pan 1000 along the second attachment section 1026.

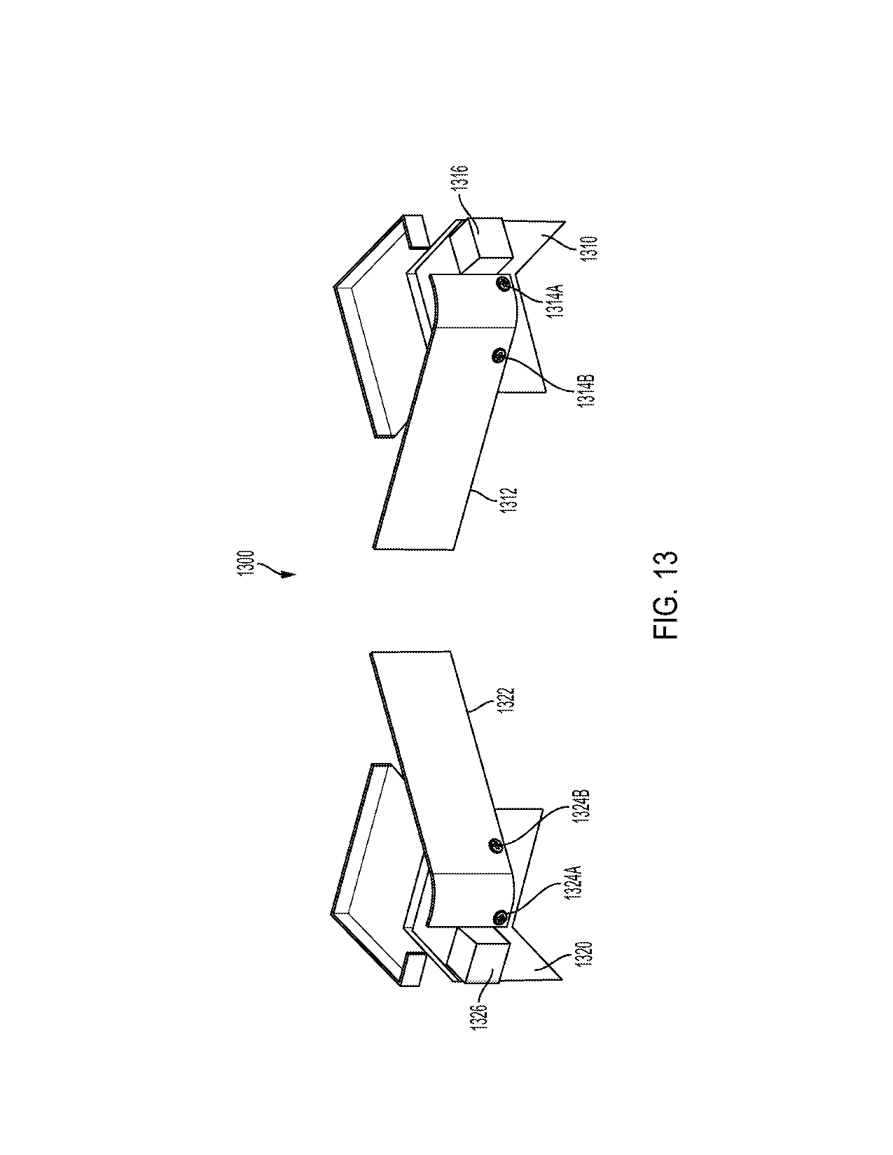

Referring to FIG. 13, a drip cup assembly 1300 is shown in greater detail. The drip cup assembly 1300 may have similar characteristics to the drip cup assembly 250. In some embodiments, the drip cup assembly 1300 may be used to substitute the drip cup assembly 250. The drip cup assembly includes a first drip cup 1302. In some embodiments, the drip cup assembly 1300 may include more than one drip cup. As shown in FIGS. 13, the drip cup assembly 1300 includes a first drip cup 1310 and a second drip cup 1320. The first drip cup 1310 may be positioned adjacent the lower edge, for example near the first corner 240 shown in FIG. 4A. In some embodiments, the second drip cup 1320 may be positioned adjacent lower edge, for example the second corner 242 shown in FIG. 4A. The drip cup assembly 1300 is configured to drain fluid, for example, water, ice, or other contaminants that may be introduced to the drip cup assembly 1300. For example, fluid, debris, and/or other contaminants may drain from the pan assembly and be introduced to the drip cup assembly 1300 where the drip cup assembly 1300 may drain the fluid, debris, and/or contaminants off of the drip cup assembly 1300 and away from the interior of the travel trailer. The drip cup assembly 1300 reduces the need for multiple parts to achieve effective water management.

In some embodiments, the drip cup assembly 1300 may include a drip cup wipe. For example, as shown in FIG. 13, the drip cup assembly 1300 may include a first drip cup wipe 1312 and a second drip cup wipe 1322. The first drip cup wipe 1312 may be coupled to the first drip cup 1310. The second drip cup wipe 1322 may be coupled to the second drip cup 1320.

The drip cup wipe may be coupled to the drip cup by one or more fasteners. As shown in FIG. 13, the first drip cup wipe 1312 is coupled to the first drip cup 1310 by a first fastener 1314A and a second fastener 1314B. Similarly, the second drip cup wipe 1322 is coupled to the second drip cup 1320 by a third fastener 1324A and a fourth fastener 1324B. In some embodiments, the drip cup wipe may be coupled to the drip cup with an adhesive.

The drip cup assembly 1300 may also include a compression member. The compression member may be coupled to the drip cup. As shown in FIG. 13, a first compression member 1316 is coupled to the first drip cup 1310. A second compression member 1326 is coupled to the second drip cup 1320. The compression member is configured to compress and reduce the wear on the drip cup as the slide out assembly is extended and retracted. In certain forms, the compression member may be made of a foam material. However, the compression member may be made of any other material that may at least partially compress, for example rubber.

The drip cup assembly 1300 is advantageous in that is serves both as a light and a debris blocker. In other words, the drip cup assembly 1300 is positioned to block at least portions of light that would enter through any gaps between the slide out assembly and the lower edge in the side wall. Similarly, the drip cup assembly 1300 is configured to block at least some debris from entering the trailer through any gaps between the slide out assembly and the lower edge in the side wall. The drip cup assembly 1300 may be configured to drain fluid and debris that may be introduced to the drip cup assembly 1300. As mentioned above, the drip cup assembly 1300 may be configured to drain fluid, debris, and/or contaminants that are on the drip cup assembly 1300 away from the interior of the travel trailer.

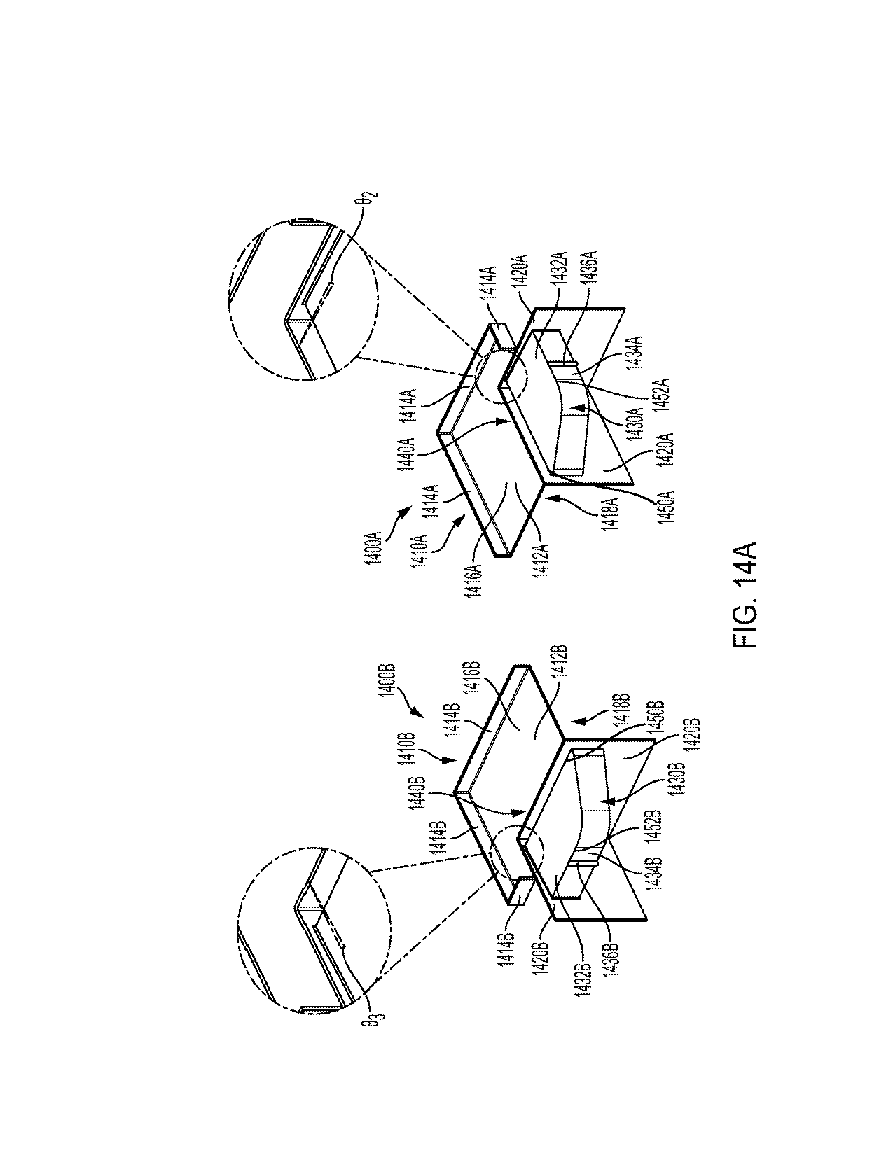

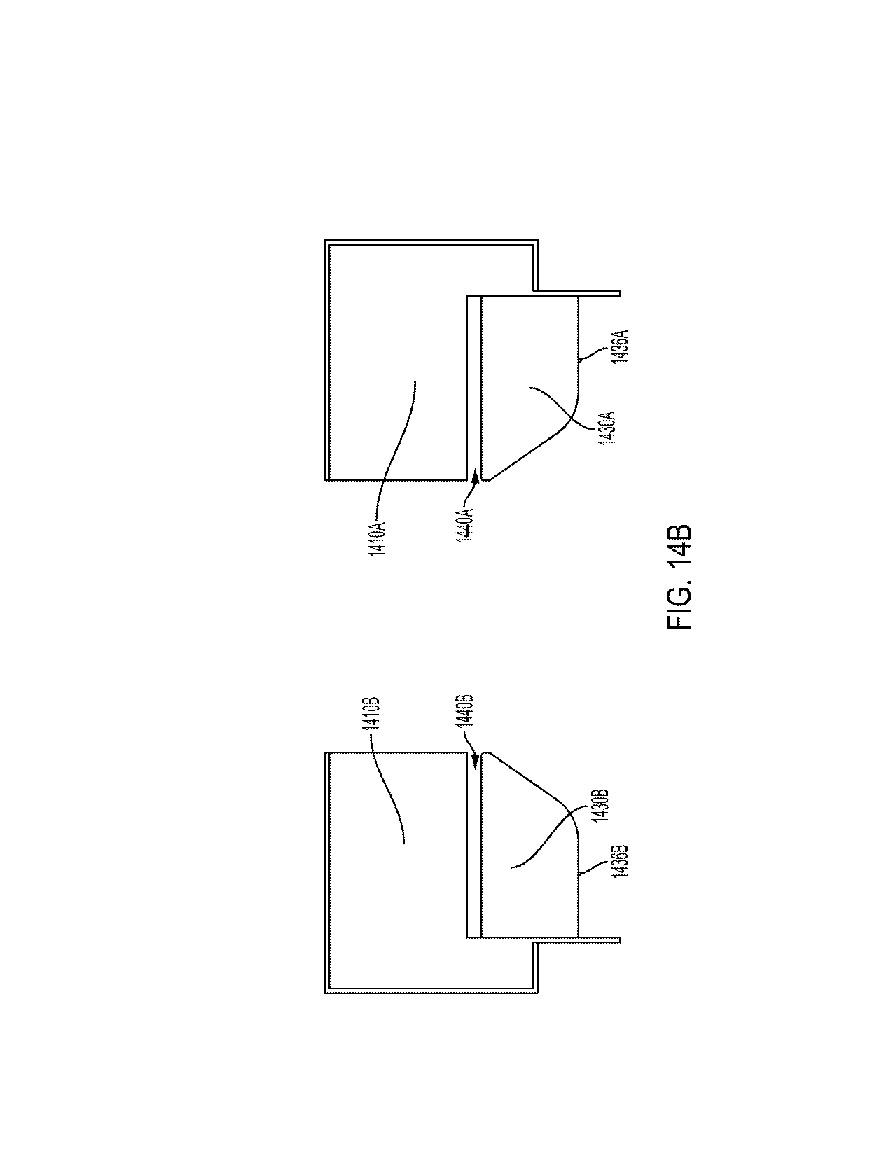

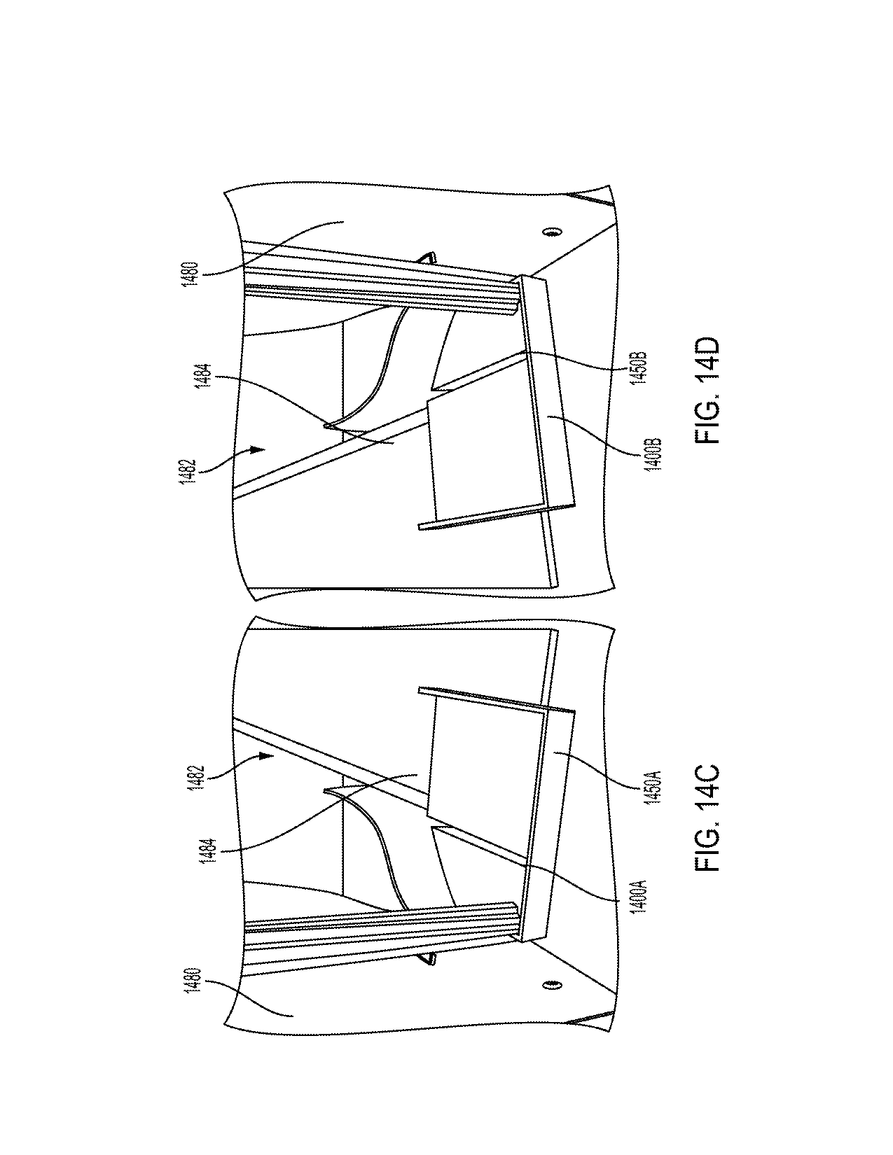

Referring to FIGS. 14A and 14B, a first drip cup 1400A and a second drip cup 1400B are shown. The first drip cup 1400A and second drip cup 1400B may substitute any of the drip cup assemblies disclosed herein, for example, as the first drip cup 1310 and the second drip cup 1320 of the drip cup assembly 1300. The drip cup may contain a first portion and a second section. For example. the first drip cup 1400A includes first portion 1410A and second portion 1430A. The second drip cup 1400B may include first portion 1410B and second portion 1430B. The first portion may include a plate. The plate may be generally “L” shaped. As shown in FIG. 14A, the first drip cup 1400A may include a plate 1412A and the second drip cup 1400B may include a plate 1412B.

The plate may at least be partially surrounded by a wall. For example, the plate 1412A may at least be partially surrounded by a wall 1414A, and the plate 1412B may at least partially surrounded by a wall 1414B. The plate may include a protrusion extending from the plate in a direction opposite the wall. For example, the wall may extend from a first surface of the plate and the protrusion may extend from a second surface of the plate. As shown in FIG. 14A, the wall 1414A may extend from a first surface 1416A of the plate 1412A and a protrusion 1420A may extend from a second surface 1418A of the plate 1412A, the first surface 1416A being opposite the second surface 1418A. Similarly, the wall 1414B may extend from a first surface 1416B of the plate 1412B and a protrusion 1420B may extend from a second surface 1418B of the plate 1412B, the first surface 1416B opposite the second surface 1418B. The protrusion and the plate are sized accordingly to fit in corners of a lower edge in a side wall, as shown in FIGS. 14C and 14D. In certain forms, the second surface may at least be partially positioned on the lower edge of the opening formed by a side wall. For example, the second surface 1418A may at least be partially positioned on a lower edge 1484 in the side wall 1480, wherein the lower edge 1484 at least partially defines an opening 1482 in the side wall 1480 as shown in FIG. 14C, and the second surface 1418B may at least be partially positioned on the lower edge 1484, as shown in FIG. 14D.

The second portion may be coupled to the first portion. More specifically, the second portion may be coupled to the protrusion of the first portion. As shown in FIGS. 14A and 14B, the second portion 1430A may be coupled to the first portion 1410A, for example to the protrusion 1420A. Similarly, the second portion 1430B may be coupled to the first portion 1410B, for example to the protrusion 1420B. The second portion may be positioned as to at least partially block debris, water, and light from entering the trailer through any gaps between the slide out assembly and the lower edge of the opening formed by the side wall. In certain forms, the second portion may be a daylight blocker.

A gap may at least be partially defined and formed by the first portion and the second section. As shown in FIGS. 14A and 14B, a gap 1440A is at least partially defined by the first portion 1410A and the second portion 1430A. A gap 1440B is at least partially defined by the first portion 1410B and the second portion 1430B. The gap may be sized accordingly to receive at least part of the pan assembly, for example the first member 724 of the pan 700, the first member 1024 of the pan 1000, or the first member 1524 of the pan 1500. Additionally or alternatively, the gap may be sized to accommodate at least part of a water divertor (not shown). Therefore, in some embodiments, the gap may be wide enough to accommodate both part of the pan assembly and part of the water divertor.

The second portion may include a second portion surface. As shown in FIG. 14A, the second portion 1430A may include a second portion surface 1432A and the second portion 1430B may include a second portion surface 1432B. In some embodiments, the second portion surface may be angled relative to the plate, for example the second portion surface may be angled relative to a surface of the plate. Angling the second portion surface relative to the plate of the first portion allows for fluids, for example, water, ice, or other contaminants to run away from the trailer 200. The second portion surface 1432A may be formed by a first edge 1450A and a second edge 1452A. The second portion surface 1432A be sloped downwardly from the first edge 1450A to the second edge 1452A. The second portion surface 1432B may be formed by a first edge 1450B and a second edge 1452B. The second portion surface 1432B may be sloped downwardly from the first edge 1450B to the second edge 1452B. The second portion surfaces 1432A and 1432B being sloped may allow for fluids, ice, and/or other contaminants to flow away from the interior of the trailer. In some embodiments, when the first drip cup 1400A and the second drip cup 1400B are coupled to the travel trailer, the first edges 1450A and 1450B may be positioned more towards the interior of the travel trailer than the second edges 1452A and 1452B, as shown in FIG. 14C and FIG. 14D.

As shown in FIG. 14A, the second portion surface 1432A may be angled relative to the plate 1412A, for example the first surface 1416A, by an angle ϴ₂. In certain forms, the angle ϴ₂ may be greater than 0° and less than 20°. In some forms, the angle ϴ₂ may be greater than 5° and less than 15°, for example 10°. In certain forms, the second portion surface may not be angled relative to the plate. In other words, the angle ϴ₂ may be equal to 0°.

Similarly, as shown in FIG. 14B, the second portion surface 1432B may be angled relative to the plate 1412B, for example the first surface 1416B, by an angle ϴ₃. In certain forms, the angle ϴ₃ may be greater than 0° and less than 20°. In some forms, the angle ϴ₃ may be greater than 5° and less than 15°, for example 10°. In certain forms, the second portion surface may not be angled relative to the plate. In other words, the angle ϴ₃ may be equal to 0°.

The second portion may include a wall. The wall may at least extend from at least part of a perimeter of the second portion surface. As shown in FIG. 14A, the second portion 1430A may include a wall 1434A, and the second portion 1430B mat include a wall 1434B.

The second portion may further include a ridge. The ridge may be coupled to the wall and/or may be integrally formed with the wall. The ridge may indicate the placement of the drip cup wipe, for example the first drip cup wipe 1312 and the second drip cup wipe 1322. As is shown in FIG. 14A, the second portion 1430A may include a ridge 1436A that is formed in and/or coupled to the wall 1434A. The second portion 1430B may include a ridge 1436B that is formed in and/or coupled to the wall 1434B.

The pan may be at least partially positioned above the drip cup assembly. For example, in some embodiments the pan assembly may be positioned at least partially above the first portion 1410A of the first drip cup 1400A and the first portion 1410B of the second drip cup 1400B. In certain forms, the pan assembly may be positioned at least partially above the plate 1412A and the plate 1412B.

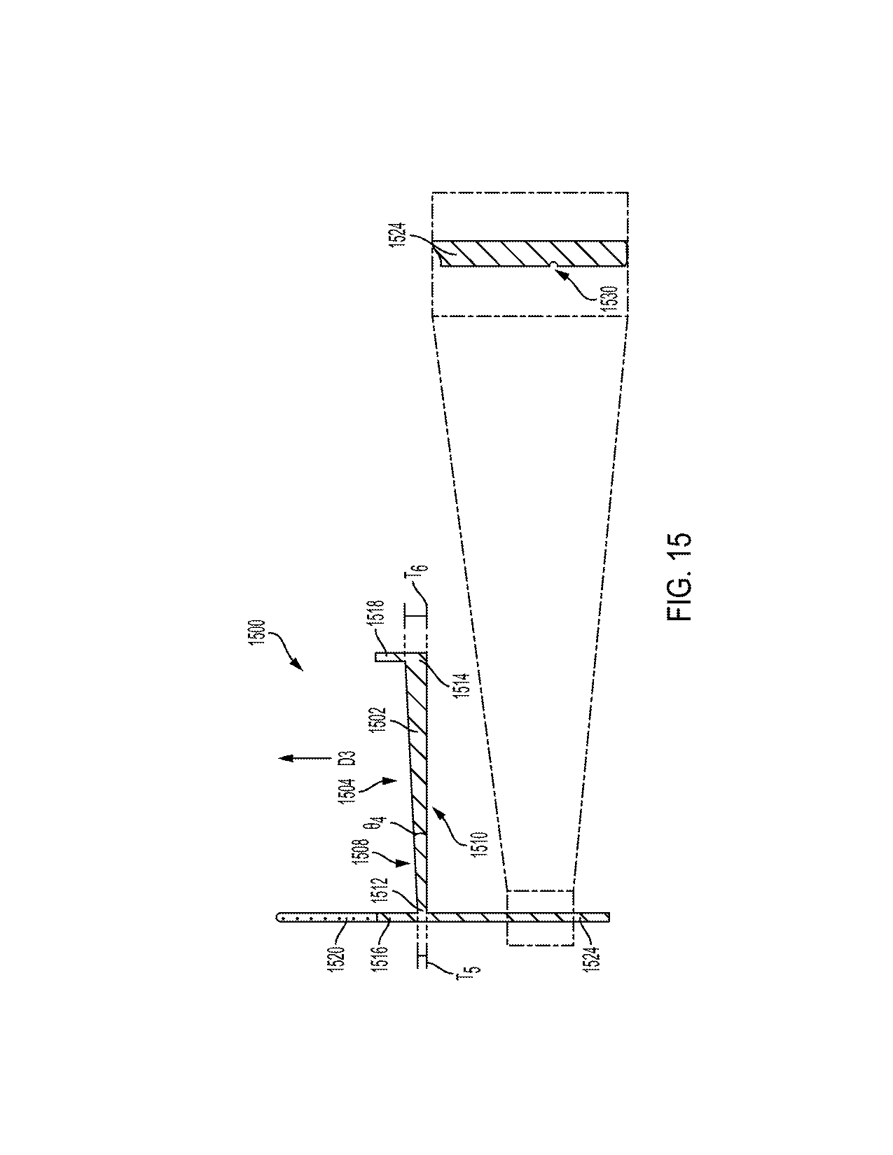

With reference to FIG. 15, one embodiment of pan 1500 is illustrated. In some embodiments, the pan 1500 may substitute the pan 280 in the pan assembly 235. The pan 1500 includes a pan body 1502 and a first attachment section 1504. The pan body 1502 may include a first edge 1512 and a second edge 1514. The pan body 1502 may also have a first surface 1508 and a second surface 1510, the second surface 1510 generally opposite the first surface 1508. The first attachment section 1504 may be positioned between the first edge 1512 of the pan and the second edge 1514 of the pan body 1502. The first attachment section 1504 may be at least partially defined by the first surface 1508.

As shown in FIG. 15, the first surface 1508 may be sloped from the first edge 1512 of the pan body 1502 to the second edge 1514 of the pan body 1502, for example, sloped downwardly from the first edge 1512 to the second edge 1514. In some embodiments, the first surface 1508 of the pan may be angled relative to the second surface 1510 of the pan body 1502 by an angle ϴ₄. In some embodiments, ϴ₄ may be between 0° and 20°. In some examples, ϴ₄ may be between 5° and 15°, for example 10°. Therefore, a first edge thickness T₅ may be less than a second edge thickness T₆. The first edge 1512 may be positioned towards the exterior of the trailer. The pan 1500 being sloped allows water, ice, or other contaminants that have been captured by the pan assembly to run towards the first edge 1512 of the pan. In some embodiments, the pan may not be sloped. In other words, the first surface 1508 of the pan body may not be angled relative to the second surface 1510 of the pan body. Therefore, the first edge thickness T₅ may be equal to the second edge thickness T₆.

The pan 1500 may further include a first lip 1516. The first lip 1516 may be coupled to the first edge 1512 of the pan 1500. The first lip 1516 may be formed integrally with the pan body 1502. In some embodiments, the first lip 1516 may extend from the first edge 1512 in a first direction D3 generally traverse to the second surface 1510 of the pan body 1502. In some embodiments, the first lip 1516 may extend along the entire length L of the pan 1500. In other embodiments, the first lip 1516 may not extend the entire length L of the pan 1500.

In some embodiments, the pan 1500 may further include a second lip 1518. The second lip 1518 may be coupled to the second edge 1514 of the pan body 1502. The second lip 1518 may be formed integrally with the pan body 1502. In certain forms, the second lip 1518 may extend from the second edge 1514 of the pan in the first direction D3. In some embodiments, the second lip 1518 may extend the entire length L of the pan. In other embodiments, the second lip 1518 may not extend the entire length L of the pan.

The pan 1500 further includes a first wipe 1520. The first wipe 1520 may be coupled to the first lip 1516. In some embodiments, the first wipe 1520 may be formed integrally with the first lip 1516. The first wipe 1520 may be sized accordingly to block light, for example the sun, from entering the trailer through any gaps between the slide out assembly and the lower edge of the opening formed by the side wall. Additionally or alternatively, the first wipe 1520 may be sized accordingly to prevent debris from entering the trailer through any gaps between the slide out assembly and the lower edge in the side wall, wherein the lower edge at least partially defines the opening in the side wall. In certain forms, the first wipe 1520 may extend at least the length L of the pan 1500. In other forms, the first wipe 1520 may not extend the length L of the pan. In certain forms the first wipe 1520 and the first lip 1516 may be formed from the same material and/or may be formed as one integral piece. In certain embodiments, the first wipe may 1520 be made of a material that is flexible. The first wipe 1520 may be configured to bend as the slide out assembly extends and retracts.

In certain embodiments, the pan 1500 may also include a first member 1524. The first member 1524 may be coupled to the first edge 1512 of the pan body 1502. The first member 1524 may extend from the first edge 1512 in a direction generally opposite the first direction D3. In certain forms, the first member 1524 and the pan body 1502 may be one integral piece. Additionally or alternatively, the first lip 1516 and the first member 1524 may be formed as one integral piece. As shown in FIG. 15, the pan 1500 may generally have an “h” or upside-down “h” cross sectional shape to it.

In certain embodiments, the pan 1500 may include one or more indicators 1530. The one or more indicators 1530 may indicate one or more locations where a fastener may be positioned to secure the pan 1500 to the travel trailer. In some embodiments, the one or more indicators 1530 may be an indentation in the pan 1500. In certain embodiments, the one or more indicators 1530 may be located on the first member 1524 of the pan 1500. In other embodiments, the one or more indicators 1530 may be located at one or more other locations on the pan 1500.

The pan 1500 may be positioned on an edge of an opening formed by a side wall of a travel trailer. For example, the second surface 1510 may be positioned on the edge of the opening formed by the side wall.

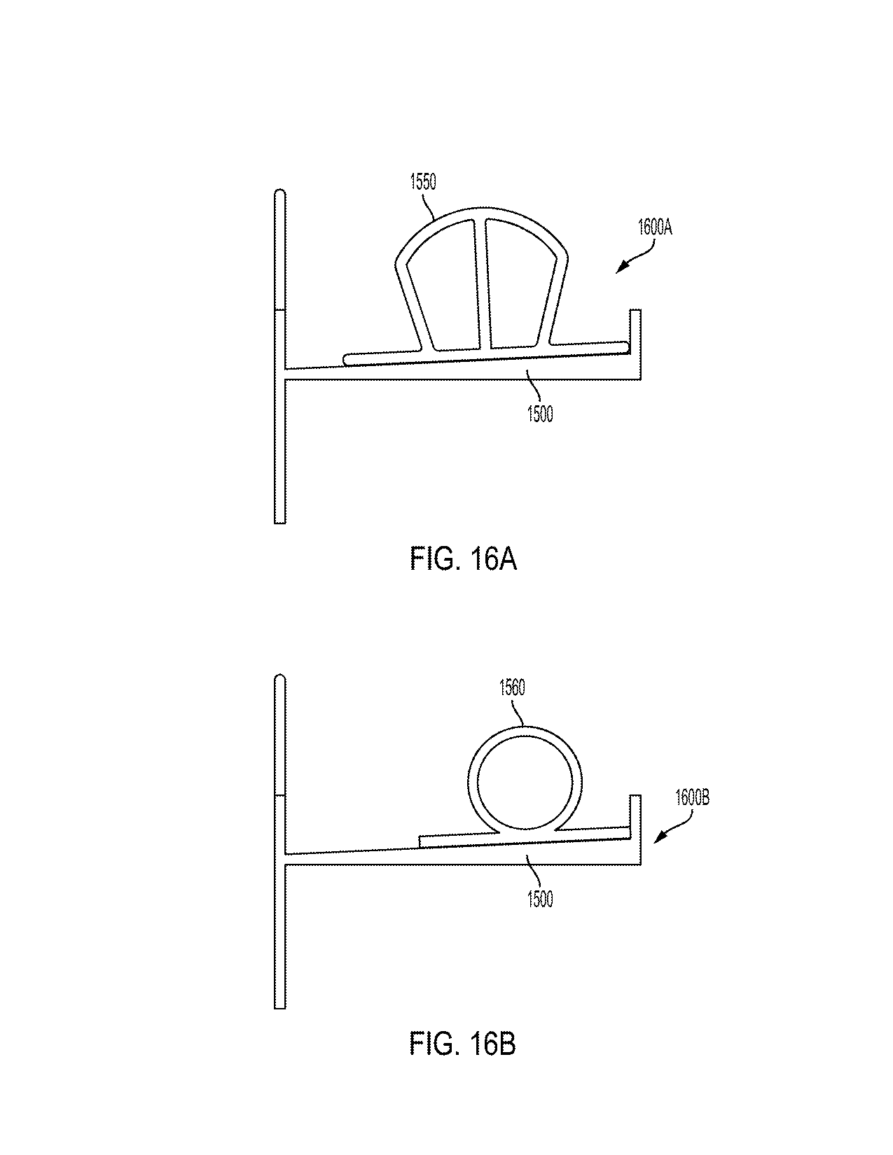

Now referring to FIG. 16A, a pan assembly 1600A is illustrated. In some embodiments, the pan assembly 1600A may be used to substitute the pan assembly 235. The pan assembly 1600A includes the pan 1500, and a support member 1550. The support member 1550 may be coupled to the pan 1500. More specifically, the support member 1550 may be removably coupled to the first surface 1508 of the pan body 1502, for example, on the first attachment section 1504.

The support members 1550 may serve a similar purpose as the support member 500 described above. In some embodiments, the support member 1550 may substitute one or more of the support members 290 in pan assembly 235. The support member 1550 is in the form of a wear bar. However, it should be understood that any other wear bar known in the art may be used in the pan assembly 235. In some embodiments, the support member 5150 may be made of a plastic material, for example polypropylene. In certain forms, the support member 1550 may be made of high impact polypropylene. The support member being made of high impact polypropylene provides the support member with sufficient structural integrity to serve both as a support and a guide to the slide out assembly. However, the support member 1550 may be made of any material that has sufficient fatigue resistance, or in other words that may support and help guide a slide out assembly without wearing out quickly.

Referring to FIG. 16B, the pan assembly 1600B is illustrated. In some embodiments, the pan assembly 1600B may be used to substitute the pan assembly 235. The pan assembly 1600B may include the pan 1500 and at least one support member 1560. The at least one support member 1560 may be coupled to the pan 1500. More specifically, the at least one support member 1560 may be removably coupled to the first surface 1508 of the pan body 1502, for example, on the first attachment section 1504. It should be understood that more than support member 1560 may be coupled to the pan 1500, for example along the first attachment section 1504.

The support member 1560 may have similar characteristics and purpose as the support members 600. For example, the support member 1560 is configured to support the slide out assembly, for example when extending and retracting between the open, partially open, and closed positions. Additionally, the support member 1560 is configured to help guide the slide out assembly when extending and retracting between the open, partially open, and closed positions. The slide out assembly is configured to extend and retract by rolling across the support member 1560.

In certain forms, a method of assembling a universal slide out pan for a travel trailer may comprise, positioning a drip cup assembly along a lower edge of an opening formed by the side wall of the travel trailer. The method may comprise positioning a first drip cup of the drip cup assembly at a first corner along the lower edge. The method may further comprise positioning a second drip cup of the drip cup assembly at a second corner along the lower edge.

The method may further comprise coupling the drip cup assembly to the lower edge. For example, the method may comprise coupling the first drip cup to the first corner, and coupling the second drip cup to the second corner.

The method may further comprise positioning a pan at least partially above the drip cup assembly. For example, the method may comprise positioning a first end of a pan at least partially on the first drip cup, and positioning a second end of the pan at least partially on the second drip cup. The method may further comprise positioning a part of the pan within a gap defined by the drip cup assembly. For example, the method may comprise positioning a first member of the pan within a gap defined by the drip cup assembly.

The method may further comprise coupling the pan to the lower edge, for example via one or more fasteners. In some forms, the method may further comprise coupling the pan to the drip cup assembly.

The method may further comprise positioning a support member on a pan. For example, the method may comprise positioning the support member adjacent a first protrusion extending from the pan. In certain forms, the method may comprise positioning the support member on a first attachment section of the pan. In certain forms, positioning the support member adjacent a first protrusion may further include abutting the support member against the first protrusion. The method may further comprise removably coupling the support member to the pan. More specifically, the method may comprise removably coupling the support member to a first attachment section of the pan. As mentioned previously, removably coupling the support member to the pan allows for replacing a previous support member for a new support member without the need to change the entire pan assembly. This allows for support members to be changed to satisfy support needs of the slide out assembly. Additionally, being able to replace the support member allows for the ability to change the support member to one that satisfy the needs of guiding the slide out assembly between the closed position and the open or at least partially open positions.

The method may further comprise positioning a second support member on the pan. For example, the method may comprise positioning the second support member adjacent a second protrusion extending from the pan. In certain forms, positioning the second support member adjacent a second protrusion may further include abutting the second support member against the second protrusion. In certain forms, the method may comprise positioning the second support member between the first protrusion and the second protrusion. The method may further comprise removably coupling the second support member to the pan. More specifically, the method may comprise removably coupling the second support member to a second attachment section of the pan. As mentioned previously, removably coupling the second support member to the pan allows for replacing a previous support member for a new support member without the need to change the entire pan assembly. This allows for support members to be changed to satisfy support needs of the slide out assembly. Additionally, being able to replace the second support member allows for the ability to change the support member to one that satisfy the needs of guiding the slide out assembly between the closed position and the open or at least partially open positions.

The method may further comprise coupling a first wipe to the pan, for example coupling the first wipe to a first lip of the pan. The method may further comprise coupling a second wipe to the pan, for example coupling the second wipe to a second lip of the pan.

In certain forms, the method may comprise coupling a first drip cup wipe to the first drip cup, for example coupling the first drip cup wipe to a wall of the first drip cup. The method may further comprise positioning the drip cup wipe on the wall of the drip cup, for example positioning the first drip cup wipe adjacent to a ridge in the wall of the first drip cup. In certain forms, positioning the first drip cup wipe adjacent to the ridge in the wall of the first drip cup may include abutting the first drip cup wipe to the ridge in the wall of the first drip cup. In certain forms, coupling the first drip cup wipe to the wall of the first drip cup may include fastening the first drip cup wipe to the wall of the first drip cup with at least one fastener.

In certain forms, the method may further comprise coupling a first compression member to the wall of the first drip cup, for example coupling a first compression member made of a foam material to the wall of the first drip cup. The method may comprise positioning the first compression member adjacent to the ridge in the wall of the first drip cup. In certain forms, positioning the first compression member adjacent to the ridge in the wall of the first drip cup further includes abutting the first compression member to the ridge in the wall of the first drip cup.

Similarly, the method may comprise coupling a second drip cup wipe to the second drip cup, for example coupling the second drip cup wipe to a wall of the second drip cup. The method may further comprise positioning the second drip cup wipe adjacent to the ridge in the wall of the second drip cup. In certain forms, positioning the second drip cup wipe adjacent to the ridge in the wall of the second drip cup may include abutting the second drip cup wipe to the ridge in the wall of the second drip cup. In certain forms, coupling the second drip cup wipe to the wall of the second drip cup may include fastening the second drip cup wipe to the wall of the second drip cup with at least one fastener.

The method may further comprise coupling a second compression member to the wall of the second drip cup, for example coupling a second compression member made of a foam material to the wall of the second drip cup. The method may comprise positioning the second compression member adjacent to a ridge in the wall of the second drip cup. In certain forms, positioning the second compression member adjacent to the ridge in the wall of the second drip cup further includes abutting the second compression member to the ridge in the wall of the second drip cup.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A recreational travel trailer, comprising:
a chassis;
a body supported by the chassis, the body including a side wall that forms an opening;
a slide out assembly movably coupled relative to the side wall; and
a pan assembly coupled to an edge of the side wall, the edge of the side wall at least partially defining the opening;
wherein the pan assembly includes a pan and a support member;
wherein the support member is removably coupled to the pan and configured to at least partially support the slide out assembly.

2. The recreational travel trailer of claim 1, wherein the pan includes a top surface of the pan formed by an inner most edge and an outer most edge;
wherein the top surface slopes downwardly from the inner most edge to the outer most edge.

3. The recreational travel trailer of claim 1, wherein the support member is made of high impact polypropylene.

4. The recreational travel trailer of claim 1, wherein the pan assembly further includes a drip cup assembly coupled to at least one end of the pan, the drip cup assembly comprising:
a drip cup configured drain a fluid away positioned thereon away from the opening; and
a drip cup wipe coupled to the drip cup.

5. The recreational travel trailer of claim 4, wherein the drip cup includes a first portion and a second portion, the first portion and the second portion at least partially defining a gap configured to receive part of the pan.

6. The recreational travel trailer of claim 4, wherein the drip cup includes an upper surface formed by a drip cup inner edge and a drip cup outer edge;
wherein the upper surface slopes downwardly from the drip cup inner edge and the drip cup outer edge.

7. A pan assembly for a recreational travel trailer including a slide out assembly, the pan assembly comprising:
a pan;
a support member removably coupled to the pan;
a first wipe coupled to the pan; and
at least one drip cup coupled to an end of the pan assembly;
wherein the support member is configured to at least partially support the slide out assembly;
wherein the at least one drip cup is configured to drain a fluid positioned thereon away from the recreational travel trailer.

8. The pan assembly of claim 7, wherein the pan includes a top surface formed between an inner most edge and outer most edge, the top surface sloping downwardly from the inner most edge to the outer most edge.

9. The pan assembly of claim 7, wherein the first wipe is coupled to an outer most edge of the pan, the first wipe configured to prevent debris from entering the travel trailer between the pan and the slide out assembly when the pan assembly is coupled to the travel trailer.

10. The pan assembly of claim 7, wherein the end of the pan is at least partially positioned above the at least one drip cup to facilitate a removal of fluid from the pan into the at least one drip cup.

11. The pan assembly of claim 7, wherein the support member is a wear bar.

12. The pan assembly of claim 7, wherein the support member is a roller.

13. The pan assembly of claim 7, wherein the support member is one of a wear bar or a roller, and the pan assembly further comprises a second support member, the second support member being one of a wear bear or a roller.

14. The pan assembly of claim 13, wherein the support member is coupled to the pan at a first attachment section, the second support member is coupled to the pan at a second attachment section, the first attachment section positioned between the first wipe and the second attachment section.

15. The pan assembly of claim 7 wherein the at least one drip cup includes a first portion and a second portion defining a gap, wherein the pan assembly is at least partially positioned within the gap of the at least one drip cup.

16. A method of assembling a pan assembly to a travel trailer having a slide out assembly, the method comprising:
coupling a pan to a lower edge of a wall of the travel trailer, the lower edge at least partially defining an opening in the wall; and
removably coupling a support member to the pan;
wherein the support member is configured to at least partially support the slide out assembly.

17. The method of claim 16 further comprising removably coupling a second support member to the pan, wherein the second support member is configured to a least partially support the slide out assembly.

18. The method of claim 16, wherein removably coupling the support member further comprises removably coupling the support member on a first attachment section of the pan wherein the support member is touching a first protrusion extending from the pan.

19. The method of claim 16 further comprising coupling a drip cup on the lower edge adjacent a first end of the pan, wherein the drip cup is configured to drain a fluid positioned thereon away from the opening.

20. The method of claim 19 further comprising positioning the pan at least partially above the drip cup to facilitate a removal of fluid from the pan into the drip cup.
